(19) United States
(12) Patent Application Publication
(10) Pub. No.: US 2026/0172595 A1
(43) Pub. Date: Jun. 18, 2026

(54) DECODER-SIDE AFFINE MOTION REFINEMENT

(71) Applicant: Alibaba (China) Co., Ltd., Hangzhou (CN)

(72) Inventors: Li Yu, Wuhan (CN); Yucheng Zhong, Wuhan (CN); Jiabao Zhu, Wuhan (CN); Hongbo Li, Wuhan (CN); Jie Chen, Beijing (CN); Ru-Ling Liao, Sunnyvale, CA (US); Yan Ye, San Diego, CA (US)

(21) Appl. No.: 19/390,563

(22) Filed: Nov. 15, 2025

Related U.S. Application Data
(60) Provisional application No. 63/733,999, filed on Dec. 13, 2024.
(60) Provisional application No. 63/768,982, filed on Mar. 8, 2025.

(51) Int. Cl. H04N 19/513; H04N 19/105; H04N 19/176; H04N 19/196; H04N 19/54

(52) U.S. Cl. CPC H04N 19/521; H04N 19/105; H04N 19/176; H04N 19/196; H04N 19/54

(57) ABSTRACT

An AVS3 and later-standard encoder and an AVS3 and later-standard decoder are provided, configuring one or more processors of a computing system to perform decoder-side motion vector refinement and affine motion compensation upon a same coding block. The encoder and the decoder are configured to implement one or both of refining a base motion vector of the affine model and refining non-translational parameters of the affine model by searching to minimize bilateral matching (“BM”) cost.

### RELATED APPLICATIONS

This application claims the benefit of U.S. Patent Application No. 63/733,999, entitled “DECODER-SIDE AFFINE MOTION REFINEMENT” and filed Dec. 13, 2024, and U.S. Patent Application No. 63/768,982, entitled “DECODER-SIDE AFFINE MOTION REFINEMENT” and filed Mar. 8, 2025, which are expressly incorporated herein by reference in their entirety.

### BACKGROUND

The Audio and Video coding standard workgroup (“AVS workgroup”) in China has adopted the third-generation Audio and Video coding standard (“AVS3”). AVS3 was preceded by AVS1 and AVS2, issued as China national standards in the years of 2006 and 2016, respectively. In December 2017, a call for proposals formally started AVS3 development, and in December 2018, High Performance Model (“HPM”) was chosen as a new reference software platform for AVS3 standard development. The initial technologies in HPM was inherited from AVS2 standard, and based on that, more performance improvements were made. In 2019, the first phase of the AVS3 standard was finalized, achieving over 20% coding performance gain compared with AVS2, while the second phase of AVS3 development is ongoing.

Inter-picture prediction is critical for video encoding and is conveyed through motion vectors (“MVs”). Techniques for signaling the MVs reduce the bitrate for transmission to a decoder but generate inaccurate MVs, leading to imprecise prediction. To improve prediction results, decoder-side refinement and/or compensation techniques may be used. Decoder-side Motion Vector Refinement (“DMVR”), including multi-pass DMVR and adaptive DMVR, is a coding tool to refine the MV at decoder-side without additional signaling, as the MV inheriting from the neighboring block may not perfectly match with the current block. Affine motion compensation may be used to capture the affine motion between two different frames.

Presently, the AVS workgroup is reviewing draft proposals for subsequent improvements over AVS3 techniques to be included in the successor AVS4 standard. There is a need to further improve the implementation of decoder-side motion vector refinement as provided by the AVS3 and later standards.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIGS. 1A and 1B illustrate example block diagrams of, respectively, a video encoding process and a video decoding process according to example embodiments of the present disclosure.

FIG. 2 illustrates temporal motion vector predictor (“TMVP”) derivation according to AVS3 and later standards.

FIG. 3 illustrates neighboring blocks used for spatial motion vector predictor (“SMVP”) derivation according to AVS3 and later standards.

FIG. 4 illustrates prediction directions of a motion vector angular predictor (“MVAP”) according to AVS3 and later standards.

FIG. 5 illustrates MVAP reference blocks according to AVS3 and later standards.

FIGS. 6A and 6B illustrate motion derivation in ultimate motion vector expression (“UMVE”) mode according to AVS3 and later standards.

FIG. 7 illustrates weight prediction according to angular weighted prediction (“AWP”) according to AVS3 and later standards.

FIG. 8 illustrates intra prediction angles according to AWP according to AVS3 and later standards.

FIG. 9 illustrates weight array settings according to AWP according to AVS3 and later standards.

FIG. 10 illustrates collocated sub-blocks for candidate pruning according to AVS3 and later standards.

FIGS. 11A and 11B illustrate a control point-based affine model according to AVS3 and later standards.

FIG. 12 illustrates affine motion vectors of sub-blocks calculated for each sub-block center sample according to AVS3 and later standards.

FIG. 13 illustrates sub-block pre-compensation according to decoder-side motion vector refine of AVS3 and later standards.

FIG. 14 illustrates a ½-pixel search pattern used in decoder-side motion vector refinement according to AVS3 and later standards.

FIG. 15 illustrates local luma compensation (“LIC”) model parameter estimation based on neighboring blocks in a reference picture and a current picture, according to AVS3 and later standards.

FIG. 16 illustrates LIC model parameter estimation based on neighboring blocks in a current picture only, according to AVS3 and later standards.

FIGS. 17A through 17D illustrate four pairs of samples used for LIC model parameter estimation, according to AVS3 and later standards.

FIG. 18 illustrates an inter template matching template shape according to AVS3 and later standards.

FIGS. 19A and 19B illustrate a hexagonal search pattern and a square-shape search pattern in inter template matching according to AVS3 and later standards.

FIG. 20 illustrates a square-shape search pattern used in decoder-side motion vector refinement according to example embodiments of the present disclosure.

FIG. 21 illustrates a cross-shape search pattern used in decoder-side motion vector refinement according to example embodiments of the present disclosure.

FIG. 22 illustrates a cross-shape search pattern used iteratively in decoder-side motion vector refinement according to example embodiments of the present disclosure.

FIG. 23 illustrates ½-pixel search patterns used in decoder-side motion vector refinement according to example embodiments of the present disclosure.

FIG. 24 illustrates sample padding used in decoder-side motion vector refinement according to example embodiments of the present disclosure.

FIG. 25 illustrates a diagram of a search window for each sub-block in decode-side motion vector refinement according to example embodiments of the present disclosure.

FIG. 26 illustrates a diagram of pre-interpolated samples on integer and fractional search points according to example embodiments of the present disclosure.

FIGS. 27A, 27B, and 27C illustrate refinement of affine model non-translational parameters while holding fixed an upper-left (FIG. 27A), upper-right (FIG. 27B), or lower-right (FIG. 27C) CPMV as the base MV of the affine model.

FIG. 28 illustrates an example system for implementing the processes and methods described herein for implementing decoder-side motion vector refinement.

### DETAILED DESCRIPTION

Systems and methods discussed herein are directed to implementing decoder-side motion vector refinement and affine motion compensation upon a same coding block, and more specifically while fixing affine parameters; while refining a control point motion vector; based on a cross-shape iterative search; based on a subpixel search step size; based on a 2-tap bilinear interpolation filter; upon a sub-block motion vector; and based on pre-interpolation of predictor samples.

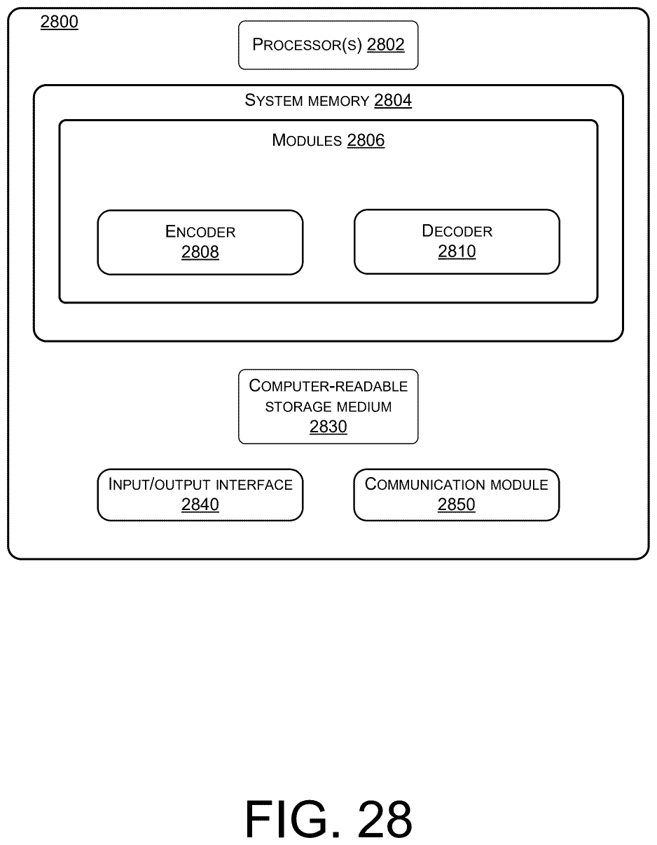

In accordance with AVS3 and later video coding standard (“AVS3 and later standard”), and motion prediction as described therein, a computing system includes at least one or more processors and a computer-readable storage medium communicatively coupled to the one or more processors. The computer-readable storage medium is a non-transient or non-transitory computer-readable storage medium, as defined subsequently with reference to FIG. 28, storing computer-readable instructions. At least some computer-readable instructions stored on a computer-readable storage medium are executable by one or more processors of a computing system to configure the one or more processors to perform associated operations of the computer-readable instructions, including at least operations of an encoder as described by AVS3 and later standards, and operations of a decoder as described by AVS3 and later standards. Some of these encoder operations and decoder operations according to AVS3 and later standards are subsequently described in further detail, though these subsequent descriptions should not be understood as exhaustive of encoder operations and decoder operations according to AVS3 and later standards. Subsequently, an “AVS3 and later-standard encoder,” and an “AVS3 and later-standard decoder” shall describe the respective computer-readable instructions stored on a computer-readable storage medium which configure one or more processors to perform these respective operations (which can be called, by way of example, “reference implementations” of an encoder or a decoder).

Moreover, according to example embodiments of the present disclosure, an AVS3 and later-standard encoder an AVS3 and later-standard decoder further include computer-readable instructions stored on a computer-readable storage medium which are executable by one or more processors of a computing system to configure the one or more processors to perform operations not specified by AVS3 and later standards. An AVS3 and later-standard encoder should not be understood as limited to operations of a reference implementation of an encoder, but including further computer-readable instructions configuring one or more processors of a computing system to perform further operations as described herein. An AVS3 and later-standard decoder should not be understood as limited to operations of a reference implementation of a decoder, but including further computer-readable instructions configuring one or more processors of a computing system to perform further operations as described herein.

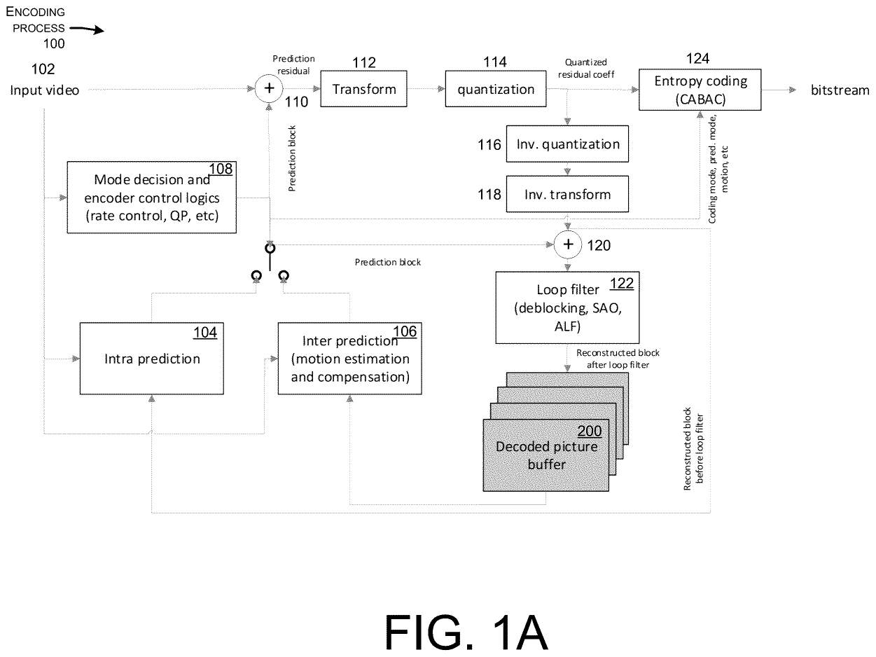

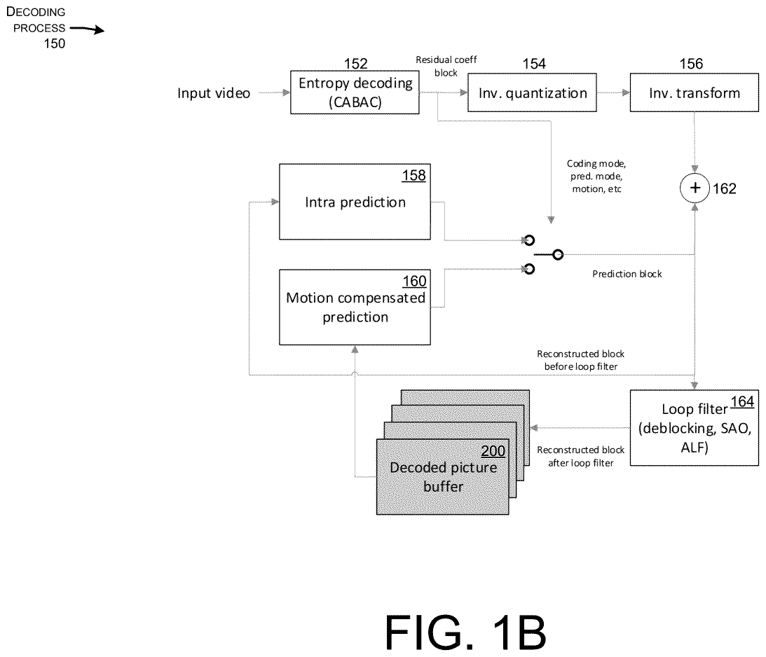

FIGS. 1A and 1B illustrate example block diagrams of, respectively, an encoding process 100 and a decoding process 150 according to an example embodiment of the present disclosure.

In an encoding process 100, an AVS3 and later-standard encoder configures one or more processors of a computing system to receive, as input, one or more input pictures from an image source 102. An input picture includes some number of pixels sampled by an image capture device, such as a photosensor array, and includes an uncompressed stream of multiple color channels (such as RGB color channels) storing color data at an original resolution of the picture, where each channel stores color data of each pixel of a picture using some number of bits. An AVS3 and later-standard encoder configures one or more processors of a computing system to store this uncompressed color data in a compressed format, wherein color data is stored at a lower resolution than the original resolution of the picture, encoded as a luma (“Y”) channel and two chroma (“U” and “V”) channels of lower resolution than the luma channel.

An AVS3 and later-standard encoder encodes a picture (a picture being encoded being called a “current picture,” as distinguished from any other picture received from an image source 102) by configuring one or more processors of a computing system to partition the original picture into units and subunits according to a partitioning structure. An AVS3 and later-standard encoder configures one or more processors of a computing system to subdivide a picture into macroblocks (“MBs”) each having dimensions of 16×16 pixels, which can be further subdivided into partitions. An AVS3 and later-standard encoder configures one or more processors of a computing system to subdivide a picture into coding tree units (“CTUs”), the luma and chroma components of which can be further subdivided into coding tree blocks (“CTBs”) which are further subdivided into coding units (“CUs”). Alternatively, an AVS3 and later-standard encoder configures one or more processors of a computing system subdivide a picture into units of N×N pixels, which can then be further subdivided into subunits. Each of these largest subdivided units of a picture can generally be referred to as a “block” for the purpose of this disclosure.

A CU is coded using one block of luma samples and two corresponding blocks of chroma samples, where pictures are not monochrome and are coded using one coding tree.

An AVS3 and later-standard encoder configures one or more processors of a computing system to subdivide a block into partitions having dimensions in multiples of 4×4 pixels. For example, a partition of a block can have dimensions of 8×4 pixels, 4×8 pixels, 8×8 pixels, 16×8 pixels, or 8×16 pixels.

By encoding color information of blocks of a picture and subdivisions thereof, rather than color information of pixels of a full-resolution original picture, an AVS3 and later-standard encoder configures one or more processors of a computing system to encode color information of a picture at a lower resolution than the input picture, storing the color information in fewer bits than the input picture.

Furthermore, an AVS3 and later-standard encoder encodes a picture by configuring one or more processors of a computing system to perform motion prediction upon blocks of a current picture. Motion prediction coding refers to storing image data of a block of a current picture (where the block of the original picture, before coding, is referred to as an “input block”) using motion information and prediction units (“PUs”), rather than pixel data, according to intra prediction 104 or inter prediction 106.

Motion information refers to data describing motion of a block structure of a picture or a unit or subunit thereof, such as motion vectors and references to blocks of a current picture or of a reference picture. PUs can refer to a unit or multiple subunits corresponding to a block structure among multiple block structures of a picture, such as an MB or a CTU, wherein blocks are partitioned based on the picture data and are coded according to AVS3 and later standards. Motion information corresponding to a PU can describe motion prediction as encoded by a AVS3 and later-standard encoder as described herein.

An AVS3 and later-standard encoder configures one or more processors of a computing system to code motion prediction information over each block of a picture in a coding order among blocks, such as a raster scanning order wherein a first-decoded block is an uppermost and leftmost block of the picture. A block being encoded is called a “current block,” as distinguished from any other block of a same picture.

According to intra prediction 104, one or more processors of a computing system are configured to encode a block by references to motion information and PUs of one or more other blocks of the same picture. According to intra prediction coding, one or more processors of a computing system perform an intra prediction 104 (also called spatial prediction) computation by coding motion information of the current block based on spatially neighboring samples from spatially neighboring blocks of the current block.

According to inter prediction 106, one or more processors of a computing system are configured to encode a block by references to motion information and PUs of one or more other pictures. One or more processors of a computing system are configured to store one or more previously coded and decoded pictures in a reference picture buffer for the purpose of inter prediction coding; these stored pictures are called reference pictures.

One or more processors are configured to perform an inter prediction 106 (also called temporal prediction or motion compensated prediction) computation by coding motion information of the current block based on samples from one or more reference pictures. Inter prediction can further be computed according to uni-prediction or bi-prediction: in uni-prediction, only one motion vector, pointing to one reference picture, is used to generate a prediction signal for the current block. In bi-prediction, two motion vectors, each pointing to a respective reference picture, are used to generate a prediction signal of the current block.

An AVS3 and later-standard encoder configures one or more processors of a computing system to code a CU to include reference indices to identify, for reference of an AVS3 and later-standard decoder, the prediction signal(s) of the current block. One or more processors of a computing system can code a CU to include an inter prediction indicator. An inter prediction indicator indicates list 0 prediction in reference to a first reference picture list referred to as list 0, list 1 prediction in reference to a second reference picture list referred to as list 1, or bi-prediction in reference to both reference picture lists referred to as, respectively, list 0 and list 1.

In the cases of the inter prediction indicator indicating list 0 prediction or list 1 prediction, one or more processors of a computing system are configured to code a CU including a reference index referring to a reference picture of the reference picture buffer referenced by list 0 or by list 1, respectively. In the case of the inter prediction indicator indicating bi-prediction, one or more processors of a computing system are configured to code a CU including a first reference index referring to a first reference picture of the reference picture buffer referenced by list 0, and a second reference index referring to a second reference picture of the reference picture referenced by list 1.

An AVS3 and later-standard encoder configures one or more processors of a computing system to code each current block of a picture individually, outputting a prediction block for each. According to AVS3 and later standards, a CTU can be as large as 128×128 luma samples (plus the corresponding chroma samples, depending on the chroma format). A CTU can be further partitioned into CUs according to a quad-tree, binary tree, or ternary tree. One or more processors of a computing system are configured to ultimately record coding parameter sets such as coding mode (intra mode or inter mode), motion information (reference index, motion vectors, etc.) for inter-coded blocks, and quantized residual coefficients, at syntax structures of leaf nodes of the partitioning structure.

After a prediction block is output, an AVS3 and later-standard encoder configures one or more processors of a computing system to send coding parameter sets such as coding mode (i.e., intra or inter prediction), a mode of intra prediction or a mode of inter prediction, and motion information to an entropy coder 124 (as described subsequently).

AVS3 and later standards provide semantics for recording coding parameter sets for a CU. It should be understood that AVS3 and later standards include semantics for recording various information, flags, and options.

An AVS3 and later-standard encoder further implements one or more mode decision and encoder control settings 108, including rate control settings. One or more processors of a computing system are configured to perform mode decision by, after intra or inter prediction, selecting an optimized prediction mode for the current block, based on the rate-distortion optimization method.

A rate control setting configures one or more processors of a computing system to assign different quantization parameters (“QPs”) to different pictures. Magnitude of a QP determines a scale over which picture information is quantized during encoding by one or more processors (as shall be subsequently described), and thus determines an extent to which the encoding process 100 discards picture information (due to information falling between steps of the scale) from MBs of the sequence during coding.

An AVS3 and later-standard encoder further implements a subtractor 110. One or more processors of a computing system are configured to perform a subtraction operation by computing a difference between an input block and a prediction block. Based on the optimized prediction mode, the prediction block is subtracted from the input block. The difference between the input block and the prediction block is called prediction residual, or “residual” for brevity.

Based on a prediction residual, an AVS3 and later-standard encoder further implements a transform 112. One or more processors of a computing system are configured to perform a transform operation on the residual by a matrix arithmetic operation to compute an array of coefficients (which can be referred to as “residual coefficients,” “transform coefficients,” and the like), thereby encoding a current block as a transform block (“TB”). Transform coefficients can refer to coefficients representing one of several spatial transformations, such as a diagonal flip, a vertical flip, or a rotation, which can be applied to a sub-block.

It should be understood that a coefficient can be stored as two components, an absolute value and a sign, as shall be described in further detail subsequently.

Sub-blocks of CUs, such as PUs and TBs, can be arranged in any combination of sub-block dimensions as described above.

An AVS3 and later-standard encoder further implements a quantization 114. One or more processors of a computing system are configured to perform a quantization operation on the residual coefficients by a matrix arithmetic operation, based on a quantization matrix and the QP as assigned above. Residual coefficients falling within an interval are kept, and residual coefficients falling outside the interval step are discarded.

An AVS3 and later-standard encoder further implements an inverse quantization 116 and an inverse transform 118. One or more processors of a computing system are configured to perform an inverse quantization operation and an inverse transform operation on the quantized residual coefficients, by matrix arithmetic operations which are the inverse of the quantization operation and transform operation as described above. The inverse quantization operation and the inverse transform operation yield a reconstructed residual.

An AVS3 and later-standard encoder further implements an adder 120. One or more processors of a computing system are configured to perform an addition operation by adding a prediction block and a reconstructed residual, outputting a reconstructed block.

An AVS3 and later-standard encoder further implements a loop filter 122. One or more processors of a computing system are configured to apply a loop filter, such as a deblocking filter, a sample adaptive offset (“SAO”) filter, and adaptive loop filter (“ALF”) to a reconstructed block, outputting a filtered reconstructed block.

An AVS3 and later-standard encoder further configures one or more processors of a computing system to output a filtered reconstructed block to a decoded picture buffer (“DPB”) 200. A DPB 200 stores reconstructed pictures which are used by one or more processors of a computing system as reference pictures in coding pictures other than the current picture, as described above with reference to inter prediction.

An AVS3 and later-standard encoder further implements an entropy coder 124. One or more processors of a computing system are configured to perform entropy coding, wherein, according to the Context-Sensitive Binary Arithmetic Codec (“CABAC”), symbols making up quantized residual coefficients are coded by mappings to binary strings (subsequently “bins”), which can be transmitted in an output bitstream at a compressed bitrate. The symbols of the quantized residual coefficients which are coded include absolute values of the residual coefficients (these absolute values being subsequently referred to as “residual coefficient levels”).

Thus, the entropy coder configures one or more processors of a computing system to code residual coefficient levels of a block; bypass coding of residual coefficient signs and record the residual coefficient signs with the coded block; record coding parameter sets such as coding mode, a mode of intra prediction or a mode of inter prediction, and motion information coded in syntax structures of a coded block (such as a picture parameter set (“PPS”) found in a picture header, as well as a sequence parameter set (“SPS”) found in a sequence of multiple pictures); and output the coded block.

An AVS3 and later-standard encoder configures one or more processors of a computing system to output a coded picture, made up of coded blocks from the entropy coder 124. The coded picture is output to a transmission buffer, where it is ultimately packed into a bitstream for output from the AVS3 and later-standard encoder. The bitstream is written by one or more processors of a computing system to a non-transient or non-transitory computer-readable storage medium of the computing system, for transmission.

In a decoding process 150, an AVS3 and later-standard decoder configures one or more processors of a computing system to receive, as input, one or more coded pictures from a bitstream.

An AVS3 and later-standard decoder implements an entropy decoder 152. One or more processors of a computing system are configured to perform entropy decoding, wherein, according to CABAC, bins are decoded by reversing the mappings of symbols to bins, thereby recovering the entropy-coded quantized residual coefficients. The entropy decoder 152 outputs the quantized residual coefficients, outputs the coding-bypassed residual coefficient signs, and also outputs the syntax structures such as a PPS and a SPS.

An AVS3 and later-standard decoder further implements an inverse quantization 154 and an inverse transform 156. One or more processors of a computing system are configured to perform an inverse quantization operation and an inverse transform operation on the decoded quantized residual coefficients, by matrix arithmetic operations which are the inverse of the quantization operation and transform operation as described above. The inverse quantization operation and the inverse transform operation yield a reconstructed residual.

Furthermore, based on coding parameter sets recorded in syntax structures such as PPS and a SPS by the entropy coder 124 (or, alternatively, received by out-of-band transmission or coded into the decoder), and a coding mode included in the coding parameter sets, the AVS3 and later-standard decoder determines whether to apply intra prediction 156 (i.e., spatial prediction) or to apply motion compensated prediction 158 (i.e., temporal prediction) to the reconstructed residual.

In the event that the coding parameter sets specify intra prediction, the AVS3 and later-standard decoder configures one or more processors of a computing system to perform intra prediction 158 using prediction information specified in the coding parameter sets. The intra prediction 158 thereby generates a prediction signal.

In the event that the coding parameter sets specify inter prediction, the AVS3 and later-standard decoder configures one or more processors of a computing system to perform motion compensated prediction 160 using a reference picture from a DPB 200. The motion compensated prediction 160 thereby generates a prediction signal.

An AVS3 and later-standard decoder further implements an adder 162. The adder 162 configures one or more processors of a computing system to perform an addition operation on the reconstructed residuals and the prediction signal, thereby outputting a reconstructed block.

An AVS3 and later-standard decoder further implements a loop filter 164. One or more processors of a computing system are configured to apply a loop filter, such as a deblocking filter, a SAO filter, and ALF to a reconstructed block, outputting a filtered reconstructed block.

An AVS3 and later-standard decoder further configures one or more processors of a computing system to output a filtered reconstructed block to the DPB 200. As described above, a DPB 200 stores reconstructed pictures which are used by one or more processors of a computing system as reference pictures in coding pictures other than the current picture, as described above with reference to motion compensated prediction.

An AVS3 and later-standard decoder further configures one or more processors of a computing system to output reconstructed pictures from the DPB to a user-viewable display of a computing system, such as a television display, a personal computing monitor, a smartphone display, or a tablet display.

Therefore, as illustrated by an encoding process 100 and a decoding process 150 as described above, an AVS3 and later-standard encoder and an AVS3 and later-standard decoder each implements motion prediction coding in accordance with AVS3 and later specifications. An AVS3 and later-standard encoder and an AVS3 and later-standard decoder each configures one or more processors of a computing system to generate a reconstructed picture based on a previous reconstructed picture of a DPB according to motion compensated prediction as described by AVS3 and later standards, wherein the previous reconstructed picture serves as a reference picture in motion compensated prediction as described herein.

For inter prediction, a reference index indicates which previously coded picture the reference block is from and the motion vector (MV) which is the position difference between the reference block in the reference picture and the current block in the current picture is used to indicate the position of the reference block in the reference picture. For bi-prediction, two reference blocks, one from a reference picture in reference picture list 0 and the other from another reference picture in reference picture list 1 are used to generate the combined predicted block. Thus, two reference indices, list 0 reference index and list 1 reference index, and two motion vectors, a list 0 motion vector (“MV0”) and a list 1 motion vector (“MV1”), are needed for bi-prediction. The motion vector is determined by the encoder and signaled to the decoder. To minimize signaling cost, the motion vector difference (“MVD”) is signaled instead. For a decoder, a motion vector predictor (“MVP”) is derived based on the spatial and temporal neighboring block motion information and the MV is obtained by adding the MVD which is parsed from the bitstream to the MVP.

AVS3 and later standards provide multiple inter prediction modes, including direct mode, skip mode, and inter modes. For skip mode and direct mode, motion information, including reference index and motion vector, is not signaled in the bitstream but derived at the decoder side with a same rule as encoder does. These two modes share the same motion information derivation rule, and the only difference between them is that skip mode skips the signaling of the residuals by setting residuals to be zero but direct modes still has residuals signaled in the bitstream.

Compared to inter modes, bits dedicated to motion information can be conserved in skip mode and direct mode, but the encoder follows the rule specified by AVS3 and later standards to derive the motion vector and reference index to perform inter prediction, while in inter modes the encoder can choose any allowed values for motion vector and reference index as the motion vector difference and reference index are signaled. Thus, the skip mode and direct mode is suitable when motion information of the current block is close to that of spatial or temporal neighboring block, since the derivation of the motion information is based on the spatial or temporal neighboring block.

To derive motion information used in inter prediction in skip mode and direct mode, an AVS3 and later-standard encoder derives a list of motion candidates first and then select one of them to perform the inter prediction. The index of the selected candidate is signaled in the bitstream. An AVS3 and later-standard decoder derives the same list of motion candidates as the AVS3 and later-standard encoder, then uses the index parsed from the bitstream to get the motion information (including motion vector and reference index) used for inter prediction, then perform inter prediction.

Currently, AVS3 and later standards provide twelve candidates in the normal motion candidate list, including a temporal candidate (namely temporal motion vector predictor), spatial candidates (namely spatial motion vector predictor), a sub-block based spatial candidate (namely motion vector angular predictor) and a history based candidate (namely history based motion vector predictor).

The first candidate, the temporal motion vector predictor (“TMVP”), is derived from the MV of the collocated block in a particular reference frame. The particular reference frame here is specified as the reference frame with reference index being 0 in list 1 for a B frame or list 0 for a P frame. When the MV of the collocated block is unavailable, an MVP derived according to the MV of spatial neighboring blocks is used as a block-level TMVP. AVS3 and later standards also adopt sub-block-level TMVP.

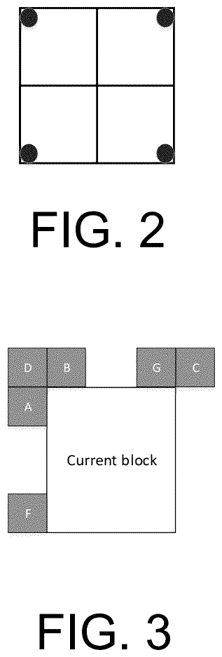

When sub-block TMVP is enabled, the current block is cross split into 4 sub-blocks as illustrated in FIG. 2, and a motion vector is derived for each sub-block. As shown in FIG. 2, for each sub-block, a corner sample is used to find the collocated block in the reference picture. A motion vector stored in the temporal motion information buffer covering the sample with the same coordinator in the reference picture as the corner sample is fetched and scaled. The scaled motion vector is used as the TMVP of each sub-block. If MV0 in the temporal motion information buffer is available (which means the collocated block has a list 0 motion vector), MV0 is used; otherwise, if MV1 in the temporal motion information buffer is available (which means the collocated block does not have a list 0 motion vector but has a list 1 motion vector), MV1 is used; otherwise, a block-level TMVP is derived and used as the TMVP for the current sub-block.

Sub-block TMVP can only be used for the block whose width and height are both larger than or equal to 16.

The second, third and fourth candidate are the spatial motion vector predictor (“SMVP”) which are derived from the 5 neighboring blocks F, G, C, B, A, D as illustrated in FIG. 3. The second candidate is a bi-prediction candidate, the third candidate is an uni-prediction candidate with reference frame in list 0, the fourth candidate is an uni-prediction candidate with reference frame in list 1. These three candidates borrow the MV and reference index of the first available block among the six neighboring blocks which has the same prediction type as the current candidate motion information the order of F, G, C, B, A, D. For the second candidate, the motion information of the first block using bi-prediction is borrowed. If there is no such block and there is more than one neighboring block using uni-prediction with reference picture list 0 and more than one neighboring block using uni-prediction with reference picture list 1, then for the second candidate, the motion information of the first block using uni-prediction with reference picture list 0 and the motion information of the first block using uni-prediction with reference picture list 1 in the order of F, G, C, B, A, D are jointly borrowed to get the motion vector and reference index for the second candidate; otherwise, the motion vector and reference index are both set to zero. For the third candidate, the motion information of the first block using uni-prediction with reference picture list 0 is borrowed. If there is no such block among the six neighboring blocks and there is more than one neighboring block using bi-prediction, then for the third, the list 0 motion information of the first bi-prediction block in the order of D, B, A, C, G, F are borrowed; otherwise the motion vector and reference index are both set to zero. For the fourth candidate, the motion information of the first block using uni-prediction with reference picture list 1 is borrowed. If there is no such block among the six neighboring blocks and there is more than one neighboring block using bi-prediction, then for the fourth candidate, the list 1 motion information of the first bi-prediction block in the order of D, B, A, C, G, F are borrowed; otherwise the motion vector and reference index are both set to zero.

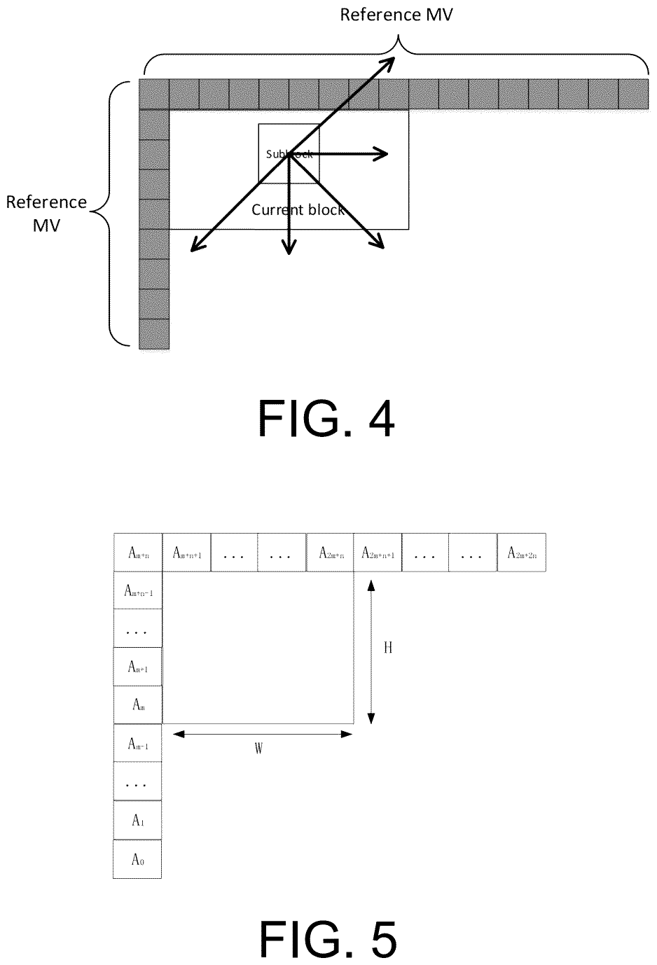

Motion vector angular predictor (“MVAP”) candidates come after SMVP. There are at most five MVAP candidates, which can be the fifth to the ninth candidates. The MVAP candidates are derived by angular prediction in five difference directions from the reference motion information which are the MVs and reference indices of the neighboring blocks as illustrated in FIG. 4. The reference motion information is first checked at 4×4 block-level. The neighboring 4×4 blocks to be checked are indicated in FIG. 5. If the motion information in a 4×4 neighboring block is not available, it is filled with neighboring available MV and reference index.

Availability of five directions will also be checked by comparing the reference motion information. Only available directions are used to predict the MV of each 8×8 sub-block within the current block, resulting in a number of MVAP candidates between 0 to 5. The first MVAP candidate is available only when A_{m-1+H/8} and Aₘ₊ₙ₋₁ have different motion information. The second MVAP candidate is available only when A_{m+n+1+W/8} and Aₘ₊ₙ₊₁ have different motion information. The third MVAP candidate is available only when Aₘ₊ₙ₋₁ and Aₘ₊ₙ have different motion information. The fourth MVAP candidate is available only when A_{W/8-1} and Aₘ₋₁ have different motion information. The fifth MVAP candidate is available only when A_{m+n+1+W/8} and A₂ₘ₊ₙ₊₁ have different motion information.

Since the MV prediction is applied to each 8×8 sub-block within the current block, the MVAP candidate is a sub-block-level candidate, which means different sub-blocks within the current block may have different MVs and reference indices.

History-based motion vector predictor (“HMVP”) candidates follow MVAP candidates. HMVP candidates are derived from motion information of the previously encoded or decoded blocks. After encoding or decoding an inter coded block, the motion information is inserted as a last entry of a HMVP table, wherein the size of the HMVP table is set to 8. If there are already 8 candidates in the table, the first candidate is removed when the current motion information is inserted into the table to maintain the number of the candidates in the table is no larger than 8.

Additionally, when inserting a new candidate, a redundancy check is first applied. If there is already an identical motion candidate in the table, this identical motion candidate is moved to the last entry of the table instead of inserting the new one to avoid redundancy among candidates in the table.

Candidates in the HMVP table are used as HMVP candidates for skip mode and direct mode. The HMVP table is checked from the last entry to the first entry. If a candidate in HMVP table is identical to one of TMVP candidate or SMVP candidate, this candidate is not put into candidate list of skip mode and direct mode; if a candidate in HMVP table is not identical to any TMVP candidate or SMVP candidate in the normal candidate list of skip mode and direct mode, the candidate in HMVP table is put into the candidate list of skip mode and direct mode as a HMVP candidate. This process is called pruning according to the present disclosure. Candidates in the HMVP table are checked one by one until the normal candidate list of skip mode and direct mode is full or all the candidates in the HMVP table are checked.

After inserting the HMVP candidates, if the normal candidate list of skip mode and direct mode is still not full, the last candidate is repeated until the candidate list is full.

In addition to skip mode and direct mode, where the implicitly derived motion information is used to find the reference block for inter prediction, ultimate motion vector expression (“UMVE”) is also adopted in AVS3 and later standards as another way to derive motion information.

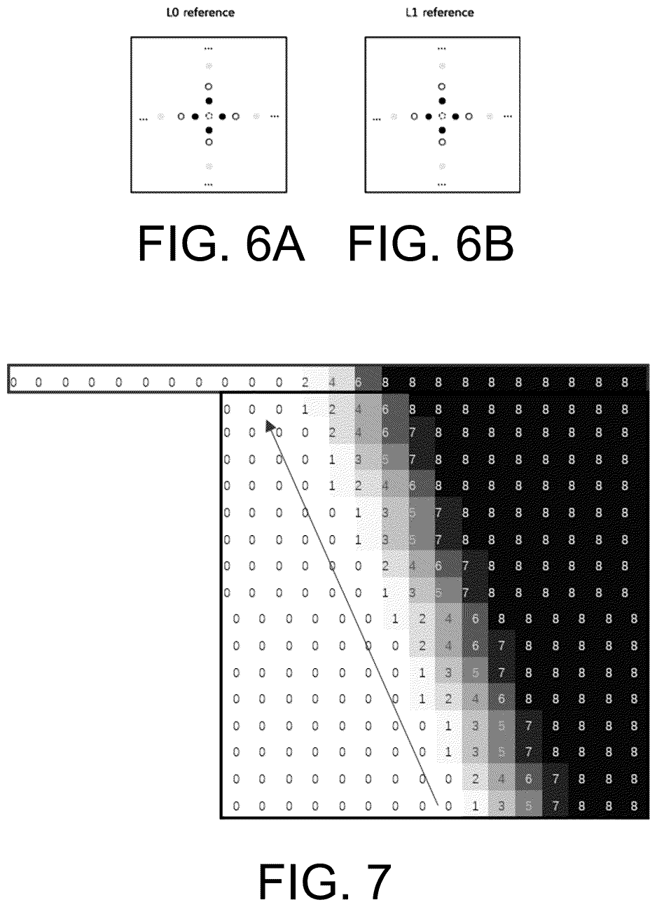

According to UMVE, based on a base candidate index signaled in the bistream, a base motion candidate is selected from UMVE candidate list which only contains two candidates. After that, the base motion candidate is further refined according to the signaled information on motion vector offset. The further information includes an index to specify offset motion distance, and an index for indication of offset motion direction. The base motion vector is set as the starting point for the refinement. Direction index represents the direction of the MVD offset relative to the starting point. The direction index can represent one of the four directions as illustrated in FIGS. 6A and 6B. Distance index specifies motion offset magnitude information. The relationship of distance index and pre-defined offset value is specified in Table 1 (five MVD offsets) and Table 2 (eight MVD offsets) below. A flag is signaled in the picture header to determine whether to use Table 1 or Table 2.

| | | | | | |
|---|---|---|---|---|---|
| MVD offset (pel) | ¼ | ½ | 1 | 2 | 4 |

| | | | | | |
|---|---|---|---|---|---|
| MVD offset (pel) | 1/4 | 1/2 | 1 | 2 | 4 |

| | | | | | | | | |
|---|---|---|---|---|---|---|---|---|
| MVD offset (Pel) | 1/4 | 1/2 | 1 | 2 | 4 | 8 | 16 | 32 |

In AVS3 and later standards, an angular weighted prediction mode is adopted for skip mode and direct mode. The AWP mode is indicated by a flag signaled in the bitstream. In the AWP mode, a motion vector candidate list, which contains five different uni-prediction motion vectors derived from spatial neighboring blocks and temporal motion vector predictor, is firstly constructed. To construct the uni-prediction candidate list, the motion information of temporal collocated block, denoted as T, and the spatial neighboring block F, G, C, A, B, D shown as FIG. 3 are inserted into the candidate list in order. The neighboring block is a uni-prediction block, the motion information is directly inserted into the candidate list; if the neighboring block is a bi-prediction block, according to the current candidate index parity, only the list 0 motion information or the list 1 motion information is inserted. After inserting all the neighboring motion information, if the candidate list is not full, additional candidates are derived based on the existing candidate in the list until the candidate list is full. After uni-prediction candidate list in constructed, two uni-prediction motion vectors are selected from the motion vector candidate list according to the two candidate indices signaled in the bitstream to get the two reference blocks.

According to AVS3 and later standards, an angular weighted prediction mode is adopted for skip mode and direct mode. The AWP mode is indicated by a flag signaled in the bitstream. In the AWP mode, a motion vector candidate list, which contains five different uni-prediction motion vectors derived from spatial neighboring blocks and temporal motion vector predictor, is firstly constructed. To construct the uni-prediction candidate list, the motion information of temporal collocated block, denoted as T, and the spatial neighboring blocks F, G, C, A, B, D shown in FIG. 3 are inserted into the candidate list in order. If the neighboring block is a uni-prediction block, the motion information is directly inserted into the candidate list; if the neighboring block is a bi-prediction block, according to the current candidate index parity, only the list 0 motion information or the list 1 motion information is inserted. After inserting all the neighboring motion information, if the candidate list is not full, additional candidates are derived based on the existing candidate in the list until the candidate list is full. After uni-prediction candidate list in constructed, two uni-prediction motion vectors are selected from the motion vector candidate list according to the two candidate indices signaled in the bitstream to get the two reference blocks.

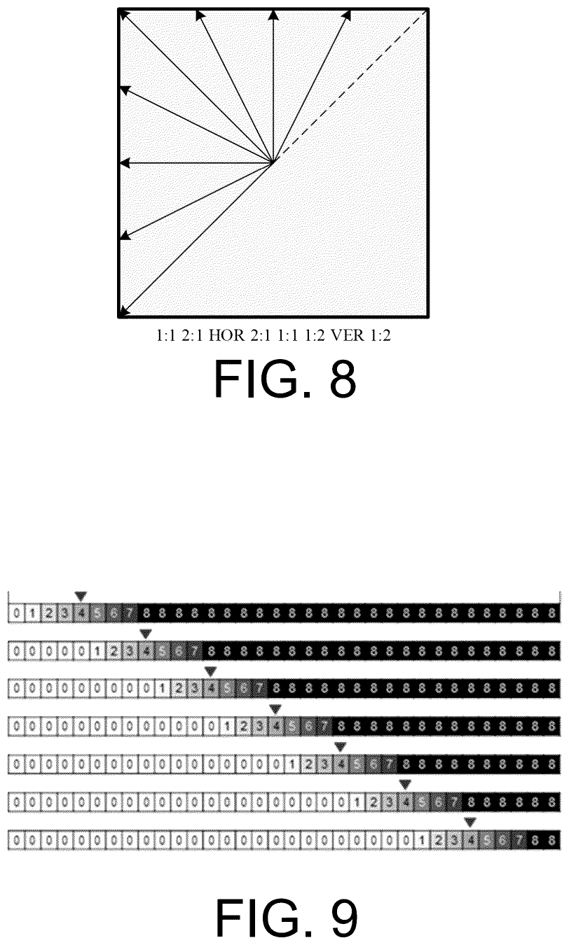

After getting the reference blocks, unlike the traditional bi-prediction inter mode where two reference blocks are averaged to get the final predicted block, AWP mode has different weights for different samples in the averaging process. The weight for each sample is predicted from a reference weight array and the value of the weight is from 0 to 8. The weight prediction is similar to the process of intra prediction mode, as illustrated in FIG. 7. For a coding block with size w×h equal to 2^{m}×2ⁿ wherein m,n∈{3 . . . 6}, right prediction directions as illustrated in FIG. 8 and seven different reference weight arrays as illustrated in FIG. 9 are supported in AWP mode. In total, there are 56 weight distributions among the samples within the block.

After determining the weight for each sample, the final predicted block is derived by weighted averaging two reference block in sample wise. Denoting the two reference blocks as P0 and P1, and the weight matrix derived as W0 and W1, the final prediction block P is calculated according to Equation 1 as follows:

$$P = ( P 0 * W 0 + P 1 * ( [ 8 ] - W 0 ) ) >> 3$$

where “*” is the point product, and “[8]” represents a matrix with all the elements equal to 8 and having the same dimension as the weight matrix.

An enhanced temporal motion vector predictor (“ETMVP”) is another way to derive motion information in AVS3 and later standards, wherein the current block is divided into 8×8 sub-blocks and each sub-block derives a motion vector based on the corresponding temporal neighboring block motion information. When the ETMVP flag signaled in the stream indicates ETMVP is enabled, a motion candidate list is constructed. Each candidate in the list contains multiple motion vectors, one for each 8×8 sub-block. For the first candidate, the motion vector of each 8×8 sub-block is derived from the motion vector of the corresponding collocated block in the reference picture with reference index equal to 0 in the reference picture list 0. For the second candidate, the current block is shifted down by 8 samples, and then the motion vector of each sub-block is derived from corresponding collocated block of the shifted block in the reference picture with reference index equal to 0 in the reference picture list 0. For the third candidate, the current block is shifted to the right by 8 samples, and then the motion vector of each sub-block is derived from corresponding collocated block of the shifted block in the reference picture with reference index equal to 0 in the reference picture list 0. For the fourth candidate, the current block is shifted up by 8 samples, and then the motion vector of each sub-block is derived from corresponding collocated block of the shifted block in the reference picture with reference index equal to 0 in the reference picture list 0. For the fifth candidate, the current block is shifted to the left down by 8 samples, and then the motion vector of each sub-block is derived from corresponding collocated block of the shifted block in the reference picture with reference index equal to 0 in the reference picture list 0. The last four candidates are pruned by comparing the motion information of two pre-defined sub-blocks in the reference picture.

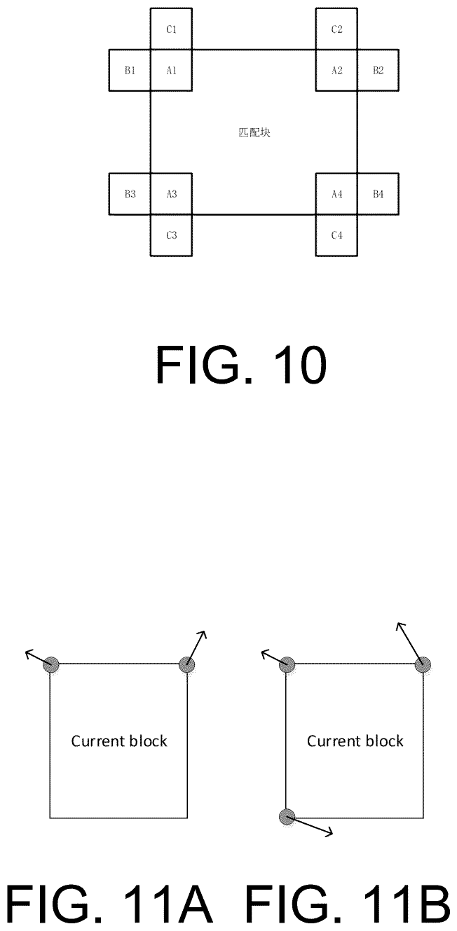

As illustrated in FIG. 10, for the second candidate, the motion information of A2 and C4 is compared; for the third candidate, motion information of A3 and B4 is compared; for the fourth candidate, motion information of A4 and C2 is compared; and for the fifth candidate, motion information of A4 and B3 is compared. If the motion information of the two blocks is not the same, the candidate is valid and inserted into the candidate list. If the number of valid candidates is less than 5, the last candidate is repeated until the candidate number is 5.

When deriving the motion vector for each sub-block, MV0 of the collocated block is used to derive MV0 of the corresponding sunblock and the list 1 motion vector of the collocated block is used to derive the list 1 motion vector of the corresponding sunblock. The reference index of list 0 and list 1 for the current sub-block are set to 0. If the collocated block is a list 0 uni-prediction block, the corresponding sub-block also uses list 0 uni-prediction; if the collocated block is a list 1 uni-prediction block, the corresponding sub-block also uses list 1 uni-prediction picture; if the collocated block is a bi-prediction block, the corresponding sub-block also uses bi-prediction; if the collocated block is an intra block, the motion vector of the corresponding sub-block is set to a default motion vector which is derived from the spatial neighboring block.

After the candidate list is constructed, the candidate is selected by the candidate index which is signaled in the bitstream.

A motion vector represents object movement between two pictures at different time instants. However, it can only represent translational movement, as all the samples in the block have the same position shift. To compensate for other kinds of motion, such as zoom in/out and rotation, affine model-based motion compensation is proposed and adopted in AVS3 and later standards.

According to affine model-based motion compensation, different samples in the block have different motion vectors. The motion vector of each sample is derived from the motion vectors of the control points according to the affine model. Control points are usually set to the corner of the block. For a 4-parameter affine model, two control points are needed as illustrated in FIG. 11A, and for a 6-parameter affine model, three control points are needed as illustrated in FIG. 11B.

For a 4-parameter affine motion model, a motion vector at sample location (x, y) in a block is derived according to Equations 2 and 3 below:

$$\{ \begin{matrix}{mv}_{x} = ax - by + {mv}_{0 x} \\ {mv}_{y} = bx + ay + {mv}_{0 y}\end{matrix}$$

$$\{ \begin{matrix}a = \frac{{mv}_{1 x} - {mv}_{0 x}}{W} \\ b = \frac{{mv}_{1 y} - {mv}_{0 y}}{W}\end{matrix}$$

For 6-parameter affine motion model, a motion vector at sample location (x, y) in a block is derived according to Equations 4 and 5 below:

$$\{ \begin{matrix}{mv}_{x} = ax + cy + {mv}_{0 x} \\ {mv}_{y} = bx + dy + {mv}_{0 y}\end{matrix}$$

$$\{ \begin{matrix}a = \frac{{mv}_{1 x} - {mv}_{0 x}}{W} \\ b = \frac{{mv}_{1 y} - {mv}_{0 y}}{W} \\ c = \frac{{mv}_{2 x} - {mv}_{0 x}}{H} \\ d = \frac{{mv}_{2 y} - {mv}_{0 y}}{H}\end{matrix}$$

where, for Equations 2 through 5, (mv₀ₓ, mv_{0y}) is a motion vector of the top-left corner control point, (mv₁ₓ, mv_{1y}) is a motion vector of the top-right corner control point, and (mv₂ₓ, mv_{2y}) is a motion vector of the bottom-left corner control point. W and H are the width and height of the coding block, respectively. (mv₀ₓ, mv_{0y}) is also called the base MV of the affine model, which controls the translational motion of the model. a, b, c and d are the non-translational parameters, which control other non-translational motions, such as flipping, rotation and scaling.

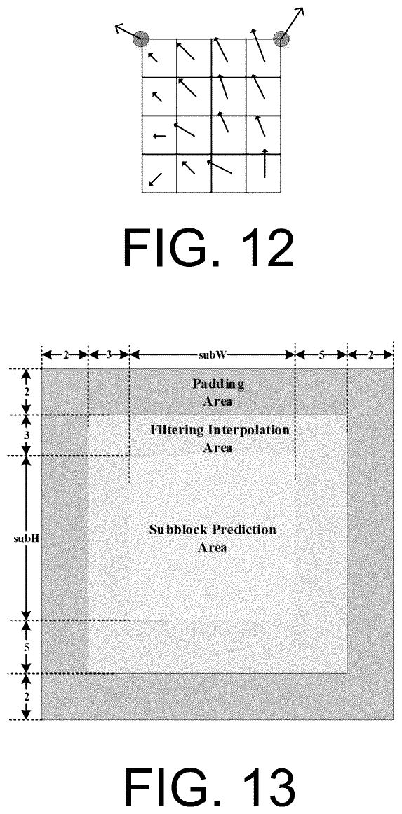

To reduce complexity of the model computation and the bandwidth of the motion compensation, the granularity of the affine motion compensation is changed from sample-level to sub-block-level. In AVS3 and later standards, 4×4 or 8×8 luma sub-block affine motion compensation is adopted wherein each 4×4 sub-block or 8×8 sub-block has a motion vector to perform motion compensation. To derive motion vector of each 8×8 or 4×4 luma sub-block, the motion vector of the center position of each sub-block, as shown in FIG. 12, is calculated according to two or three control points (“CPs”), and rounded to 1/16 fraction accuracy. Then, motion compensation is performed to generate the prediction of each sub-block with derived motion vectors.

To perform affine motion compensation, there are also two modes: affine inter mode, where the motion vector differences of control points and reference indices are signaling in the bitstream, and affine skip mode and direct mode, where the motion vector difference and reference index are not signaled but derived at the decoder side.

For affine skip mode and direct mode, the motion vectors of the control points (‘CPMVs”) of the current blocks are generated based on the motion information of the spatial neighboring blocks. There are five candidates in an affine skip mode and direct mode candidate list, and an index is signaled to indicate the candidate to be used for the current block. The affine skip mode and direct mode candidate list consists of the following three types of candidates in order:
Inherited affine merge candidates, where the CPMVs of the current block are extrapolated from the CPMVs of the spatial neighbour blocks;
Constructed affine merge candidates, where the CPMVs of the current block are borrowed from translation MVs of the different neighboring blocks; and
Zero motion vectors.

There are at most two inherited affine candidates, which are derived from affine motion model of the neighboring blocks, one from left neighboring blocks and one from above neighboring blocks. When a neighboring affine block is identified, its CPMVs are used to derive the CPMV of the current block. For constructed affine candidate, the CPMVs of the current block are constructed by combining motion information of different neighboring block. After inserting inherited affine candidates and constructed affine candidates into the affine skip mode and direct mode candidate list, if the list is still not full, zero MVs are inserted to until the list is full.

For the affine inter mode, the difference of the CPMVs of current block and the index of CPMV predictors (“CPMVPs”) are signaled in the bitstream. An affine flag is signalled in the bitstream to indicate whether affine inter mode is used, followed by another flag signalled to indicate whether 4-parameter affine or 6-parameter affine is used if affine inter mode is used. An affine CPMVP candidate list which has 2 candidates is constructed both at the encoder and decoder side. The candidate list is constructed by using the following four types of CPMVPs candidates in order:
Inherited affine candidates, where the CPMVPs are extrapolated from the CPMVs of the neighbour blocks;
Constructed affine candidates, where CPMVPs are derived from the translational motion vectors of the neighbour blocks;
Translational motion vectors from neighboring blocks; and
Zero motion vectors.

The index of CPMVP is signaled in the bitstream to indicate which candidate is used as CPMVP for the current block, and then the MVD signaled in the bitstream are added to the CPMVP to get the final value of CPMVs of the current block.

Affine motion compensation can only be applied on blocks sized larger than or equal to 16×16.

Instead of explicitly signaling an MVD in the bitstream, decoder-side motion vector refinement (“DMVR”) refines a motion vector at the decoder side according to symmetrical mechanism. Decoder-side motion vector refinement can only apply to a block with bi-prediction. The list 0 motion vector, MV0, and the list 1 motion vector, MV1, are derived first, then the refinement process is performed to refine MV0 and MV1.

DMVR is performed based on 16×16 sub-blocks. When the width and/or height of a CU are larger than 16 luma samples, it is further split into sub-blocks with width and/or height equal to 16 luma samples. The maximum unit size for a bilateral matching (“BM”) search to minimize BM cost, according to DMVR, is limited to 16×16.

Before performing bilateral matching, MV0 and MV1 are rounded to integer precision. In the bilateral matching process, the motion vectors MV0 reference picture list 0 and MV1 of reference picture list 1 are used to obtain two predicted blocks from reference picture list 0 and reference picture list 1, respectively. Before performing a bilateral matching search, the CU is divided into several sub-blocks, and for each sub-block, a reference search area is obtained. Bilateral matching is performed by only using reference samples within the reference search area.

The reference search area, as illustrated in FIG. 13 includes a padding area, an interpolation filtering area, and a sub-block prediction area. The sub-block prediction area is the predicted block of the current block referred to by initial motion vectors. The interpolation filtering area is the area of the reference samples used in the interpolation of predicted block. The size of the interpolation filtering area is determined by the interpolation filter tap; in AVS3 and later standards, it is set to 8, as 8-tap interpolation filter is used. The padding area encompasses the size of the search range. Outside the interpolation filtering area, sample padding is used in the padding area instead of actually fetching those samples in the reference picture, to reduce bandwidth.

Supposing that 8-tap interpolation filter is used in motion compensation, setting the interpolation filtering area as (block width+7)×(block height+7) will not increase the memory bandwidth. The integer reference samples in the window are fetched from the reference picture of list 0 and list 1. The position at which the sum of difference of the list 0 reference block and list 1 reference block is minimized is set as the optimal integer position.

According to DMVR, for each sub-block, two predicted blocks referred to by the initial MV0 and MV1 are obtained and the difference between these two predicted blocks are calculated as the BM cost of the initial search position. A bilateral matching search is conducted with the search center setting as the initial search position. For each search position surrounding the search center, a MV offset is added to MV0 and the same MV offset is subtracted from MV1, and then two predicted blocks can be obtained with the changed value of MV0 and MV1 and the difference between two predicted blocks is calculated as the BM cost of that search position. The position with least BM cost is set as the search center of the next search iteration. The search process continues until the maximum number of search iterations is achieved or the position with least BM cost is the search center. The BM cost is calculated as the sum of absolute difference (“SAD”) value between the two predicted blocks of reference picture list 0 and reference picture list 1.

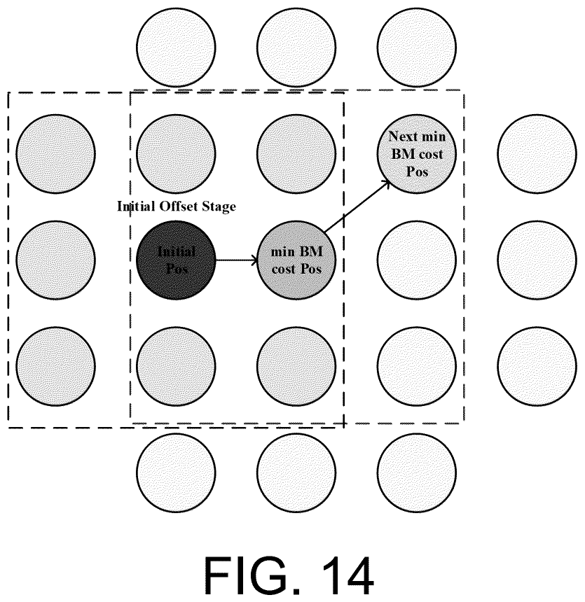

The bilateral matching search of DMVR can be divided into an integer search and a fractional search. The integer-pixel search includes three search iterations. In the first search iteration, the MV offset is determined by conducting a square-shape search iteration (as shown in the left dashed box in FIG. 14). Among all the search positions in the first iteration, the position with least BM cost is set as the search center of the next search iteration. The MV offset is determined as the difference between the initial position and the position with least BM cost. In the second search iteration, the same process is repeated and the position with least BM cost is found and set as the search center of the next search iteration. If the position with least BM cost is the search center, the search process terminates. The final best integer-pixel position is obtained by at most three search iterations. The MV offset obtained in the integer search is the distance between the best integer position and the initial position.

After the integer search, the subpixel position is calculated as follows. To reduce computational complexity, the subpixel position is derived using a parameter error surface equation instead of performing additional searches based on SAD comparison. The subpixel position calculation is conditionally invoked based on the output of the integer search. Subpixel position calculation will only be performed when the MV offset obtained in the integer search is less than 1 pixel (within the right dashed box in FIG. 14).

To determine the subpixel position, the BM cost of the best integer position and the neighboring positions are used to estimate the quadratic distortion surface near the best integer optimal position. The position with least distortion in the distortion surface is selected as the best subpixel position. The horizontal subpixel position is estimated using the left, right, and center pixels, while the vertical subpixel position is estimated using the top, bottom, and center pixels. The formulas are Equations 6 and 7 as follows:

$$Hortizontal subpixel position = \frac{( {SAD}_{left} - {SAD}_{right} ) * {precision}_{N}}{( {SAD}_{left} + {SAD}_{r ight} - 2 * {SAD}_{mid} ) * {precision}_{N}} \\ Vertical subpixel position = \frac{( {SAD}_{bottom} - {SAD}_{top} ) * {precision}_{N}}{( {SAD}_{bottom} + {SAD}_{top} - 2 * {SAD}_{mid} ) * {precision}_{N}}$$

where precision_{N} is 4 when the highest precision is ¼, and 16 when the highest precision is 1/16.

DMVR is used for skip mode and direct mode to refine motion vectors to improve the prediction accuracy. DMVR is performed without signaling when the current block meets the following conditions:
One reference picture is in the past and another reference picture is in the future with respect to the current picture;
The distances (i.e., POC difference) from two reference pictures to the current picture are same;
Both CU height and CU width are larger than or equal to 8;
AWP mode is not used for the current block;
ETMVP mode is not used for the current block;
IPC mode is not used for the current block;
INTER_TM mode is not used for the current block;
AFFINE mode is not used for the current block; and
AFFINE UMVE mode is not used for the current block.

Bi-directional optical flow (“BIO”) is another way to refine the predicated sample values for the bi-prediction block in skip mode and direct mode. Whereas traditional bi-prediction performs a weighted average of two reference blocks to obtain the predicted block, BIO further refines the predicted block based on optical flow theory.

BIO is only applied to bi-prediction. It calculates gradient values in the horizontal direction and the vertical direction for each sample of the list 0 reference block and list 1 reference block. To calculate the gradient, the current block is divided into a 16×16 sub-block according to DMVR. For a boundary sample of the sub-block, gradient is calculated by padding the boundary sample of the sub-block instead actually fetch the sample out of the current sub-block. After gradient calculation, the refinement value is calculated for each sample based on the optical flow equation. To reduce computational complexity, it is assumed that each group of 4×4 samples share the same motion vector. Thus, each group has a refinement value. The refinement values are added to the predicted block to get the refined block.

In BIO, the gradient calculation uses an 8-tap filter, and its filter coefficients are shown in Table 3 below.

| MV position | coefficients |
|---|---|
| 0 | −4, 11, −39, −1, 41, −14, 8, −2 |
| ¼ | −2, 6, −19, −31, 53, −12, 7, −2 |
| ½ | 0, −1, 0, −50, 50, 0, 1, 0 |
| ¾ | 2, −7, 12, −53, 31, 19, −6, 2 |

There is no flag signaled in bitstream to indicate the use of BIO. BIO is applied for the blocks if all the following conditions are met:
BIO is only applied to luma component;
BIO is only applied to bi-prediction;
The forward reference frame and the backward reference frame are on both sides of the current frame; and

The current motion vector accuracy is quarter-pixel.

Bi-directional gradient correction (“BGC”) is another technology to refine the predicted sample values for the bi-prediction block in inter mode. The BGC calculate the difference between two reference blocks, one in a list 0 reference picture and the other in a list 1 reference picture, as the temporal gradient. The temporal gradient is scaled and added to the predicted block generated by two reference blocks to further correct the predicted block. For bi-prediction inter mode, the prediction block, Pred_{BI}, is generated by averaging the two reference blocks Pred₀ and Pred₁ which are obtained from list 0 reference picture and list 1 reference picture with two different motion vectors. The BGC further calculates the corrected prediction block Pred according to Equation 8 as follows:

$$Pred = \{ \begin{matrix}{Pred}_{B 1} , & BgcFlag = 0 \\ {Pred}_{B 1} + ( ( {Pred}_{1} - {Pred}_{0} ) ≫ k ) , & BgcFlag = 1 , BgcIdx = 0 \\ {Pred}_{B 1} + ( ( {Pred}_{0} - {Pred}_{1} ) ≫ k ) , & BgcFlag = 1 , BgcIdx = 1\end{matrix}$$

where k is the correct intensity factor and is set to 3 in AVS3 and later standards. For a block that is coded in bi-prediction inter mode and satisfies the BGC application conditions, a flag, BgcFlag, is signaled to indicate whether BGC is used or not. When BGC is used, an index, BgcIdx, is further signaled to indicate how to correct the predicted block using temporal gradient. Both BgcFlag and BgcIdx are signaled using context coded bins.

BGC is only applied to bi-prediction mode. For skip mode and direct mode, BgcFlag and BgcIdx are inherited from the neighboring block together with other motion information.

In AVS3 and later standards, inter prediction filtering is the last step to generate the final predicted block. It is only applied to predicted block coded with normal direct mode. If the current block is coded by normal direct mode, a flag is signaled to indicate whether InterPF is used or not. If InterPF is used, an index is signaled to indicate which filter is applied. There are two filters can be selected by the encoder. At decoder-side, an AVS3 and later-standard decoder performs the same filter operation as encoder according to the syntax elements signaled in the bitstream.

When interPF is enabled, if the interPF index is equal to 0, the filtering process proceeds according to the following Equations 9, 10, 11, and 12. The left and above neighboring reconstructed samples are used to filter the current predicted samples by weighted averaging.

$$Pred ( x , y ) = ( Pred\_inter ( x , y ) \times 5 + Pred\_Q ( x , y ) \times 3 ) >> 3$$

$$Pred\_Q ( x , y ) = ( Pred\_V ( x , y ) + Pred\_H ( x , y ) + 1 ) >> 2$$

$$Pred\_V ( x , y ) = ( ( h - 1 - y ) \times Rec ( x , - 1 ) + ( y + 1 ) \times Rec ( - 1 , h ) + ( h >> 1 ) ) >> log 2 ( h )$$

$$Pred\_H ( x , y ) = ( ( w - 1 - x ) \times Rec ( - 1 , y ) + ( x + 1 ) \times Rec ( w , - 1 ) + ( w >> 1 ) ) >> log 2 ( w )$$

where Pred_inter(x, y) is the predicted sample to be filtered, Pred(x, y) is the filtered predicted sample, and (x, y) is the coordinate of the sample. Rec(x, y) represents the reconstructed neighboring pixels at position (x, y). The width and height of the current block are represented by w and h, respectively.

If the interPF index is equal to 1, the filtering process proceeds according to the following Equation 13:

$$Pred ( x , y ) = ( f ( x ) \times Rec ( - 1 , y ) + f ( y ) \times Rec ( x , - 1 ) + ( 64 - f ( x ) - f ( y ) ) \times Pred\_inter ( x , y ) + 32 ) >> 6$$

where Pred_inter(x, y) is the predicted sample to be filtered, Pred(x, y) is the filtered predicted sample, and (x, y) is the coordinate of the sample. Rec(x, y) represents the reconstructed neighboring pixels at position (x, y). f(x) and f(y) can be obtained by a lookup table as shown in Table 4 below.

| | w or h | | | | |
|---|---|---|---|---|---|
| x or y | 4 | 8 | 16 | 32 | 64 |
| 0 | 24 | 44 | 40 | 36 | 52 |
| 1 | 6 | 25 | 27 | 27 | 44 |
| 2 | 2 | 14 | 19 | 21 | 37 |
| 3 | 0 | 8 | 13 | 16 | 31 |
| 4 | 0 | 4 | 9 | 12 | 26 |
| 5 | 0 | 2 | 6 | 9 | 22 |
| 6 | 0 | 1 | 4 | 7 | 18 |
| 7 | 0 | 1 | 3 | 5 | 15 |
| 8 | 0 | 0 | 2 | 4 | 13 |
| 9 | 0 | 0 | 1 | 3 | 11 |
| 10-63 | 0 | 0 | 0 | 0 | 0 |

In inter prediction, a reference block which has the same or similar content with the current block is found in the previous coded/decoded picture to predict the current block. In the scenarios with varying luminance, even if the reference block has the same content with the current block, the values of the samples in these two blocks may not be close to each other as these two blocks are in the two pictures with different luminance. Thus, to compensate the luminance changes from picture to picture in inter prediction, a linear model based local luma compensation (“LIC”) is applied on the reference block to generate a predicted block that haves the similar luminance level with the current block. Two parameters, the factor a and the offset b, are derived and applied to the reference block according to the following Equation 14:

$$y = a \times x + b$$

wherein x is the reference sample, and y is the predicted sample after luma compensation.

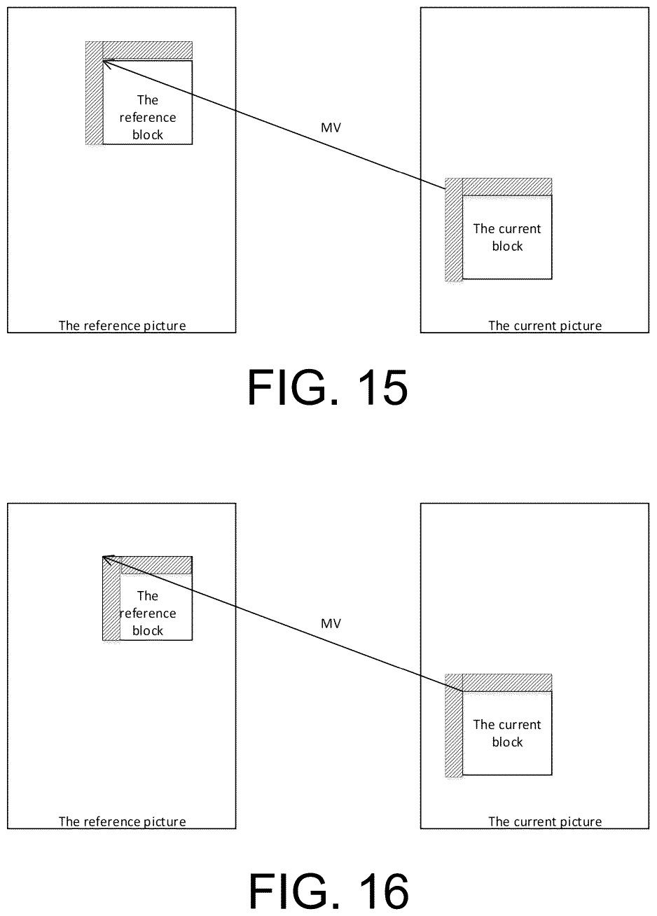

The model of luma compensation may be derived on picture level and applied to all the blocks within the picture or derived at block-level and applied on that block only. Block-level luma compensation is also called local luma compensation (“LIC”) wherein the decoder derives the parameters in the same way as the encoder so that the parameters don't need to be signaled. To derive the model parameters, the reconstructed samples and predicted samples of the neighboring blocks which are shown with the shaded areas in as illustrated in FIG. 15 are used. First, linear model parameters are estimated according to relationship between the predicted sample values and reconstructed sample values of the neighboring blocks. Then, the estimated linear model is applied on the predicted samples of the current block to generated luma compensated predicted block.

As the predicted samples of the neighboring block are used in the parameter estimation (the shaded area in the reference picture), the decoder fetches a block larger than the current block from the reference picture buffer, which increases bandwidth. To reduce the bandwidth, current predicted block based local luma compensation is proposed in which the predicted samples on the left and top boundary within the reference block are used to estimate the parameters instead of using the neighboring block samples. As shown in shaded areas in FIG. 16, the predicted samples within the left and up boundary of the reference block and the reconstructed samples of left and up neighboring blocks are used to derive the model parameters.

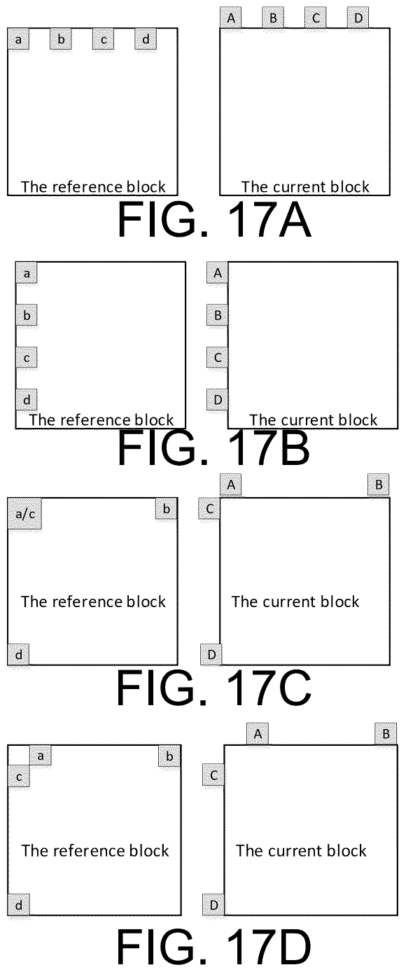

Least square estimation can be used to estimate the model parameters, but computational complexity is high. To simplify parameter estimation, four points estimation is used, wherein only four pairs of samples are used. As illustrated in FIG. 17A, four predicted samples on the top boundary within the reference block and four reconstructed samples on the top neighboring block are used; in FIG. 17B, four predicted samples on the left boundary within the reference block and four reconstructed samples on the left neighboring block are used; in FIGS. 17C and 17D, two predicted samples on the top boundary and two predicted samples on the left boundary within the reference block and two reconstructed samples on the top neighboring block and two reconstructed on the left neighboring block are used.

In the derivation process, first, samples “a”, “b”, “c”, “d” are sorted according to their values. The average of two larger values among “a”, “b”, “c”, “d” are calculated and denoted as x_max, and the average of two corresponding sample value is also calculated and denoted as y max (A is corresponding to a, B is corresponding to b, C is corresponding to c and D is corresponding to d). The average of two smaller values among “a”, “b”, “c”, “d” are calculated and denoted as x_min, and the average of two corresponding sample value is also calculated and denoted as y_min. Second, the parameters of linear model, a and b, are derived according to the following Equations 15 and 16:

$$a = ( ( y\_max - y\_min ) \times ( 1 << shift ) / ( x\_max - x\_min ) ) >> shift$$

$$b = y\_min - a \times x\_min$$

wherein shift is the bit shift number and/denotes integer division.

Template matching is a new inter prediction method (namely Inter TM) proposed for successor standards to AVS3. It refines the motion vector derived in skip mode and direct mode based on template matching. At the encoder side, the process begins with using the MVP list generation method in skip mode and direct mode. Then the first four MV candidate in the list are selected which include one TMVP candidate and three Spatial MVP candidates with reference directions setting as bi-prediction, bi-prediction, uni-prediction, and uni-prediction, respectively. The reference information of the four candidates is shown in Table 5 below.

| Order | 1 | 2 | 3 | 4 |
|---|---|---|---|---|
| Type | TMVP | SMVP | | |
| Reference list | List 0 and list 1 | List 0 and list 1 | List 0 | List 1 |

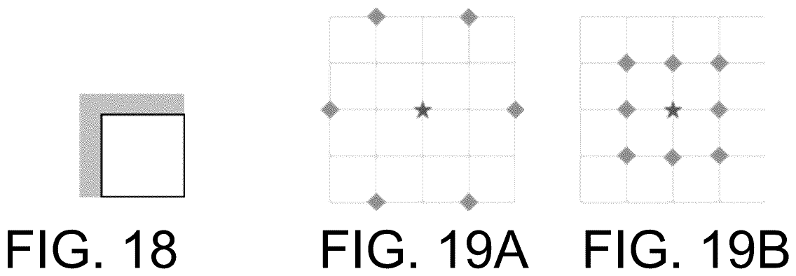

An encoder then removes duplicates from the MVPs by checking if the two bi-prediction candidates are identical and rounds the MVPs to integer-pixel position. A template (with a width of 4) is constructed using the already reconstructed pixels surrounding the current block, and the MVP list is sorted such that candidates with smaller template costs are placed at the front. The template shape is shown in FIG. 18. The template matching cost is calculated as the difference between the template of the current block which consists of the reconstructed samples as shown in FIG. 18 and the template of the reference block. The SAD or sum of absolute transformed difference (“SATD”) are used as TM cost.

According to TM-based refinement of the MVPs, a hexagonal search pattern is searched initially, performing up to 30 searches while employing the SAD method to calculate the template cost. The point with the lowest TM cost is selected as the center for the next search iteration, and if the center point is with least TM cost in a search iteration, the current hexagonal search terminates. Finally, a square-shape search pattern is searched once more to find the best MV. The MV refined by template matching is used as the final MV for the current block and used to generate the prediction block for the current block. The index of the best MVP is encoded into the bitstream using variable-length coding. Square-shape search and hexagonal-shape search patterns are illustrated in FIG. 19; other search patterns such as a cross-shape search pattern, a diamond-shape search pattern, and the like can also be used.

DMVR is a coding tool to refine the motion vector in the decoder side without additional signaling, as the motion vector inheriting from the neighboring block may not perfectly match with the current block. Affine motion compensation is used to capture the affine motion between two different frames. However, according to the current design, these two coding tools are mutually exclusive: DMVR is only applied on non-affine coded block to refine motion vector of translation motion. For blocks coded with affine mode, DMVR cannot be used to refine the motion vectors. However, similar to translation motion compensation coded blocks, the motion vectors of the affine skip mode and direct mode coded block are also inherited from the previously coded blocks and thus may not perfectly match with the current block. Thus, DMVR can also refine the motion vector in this case.

According to example embodiments of the present disclosure, an AVS3 and later-standard encoder and decoder apply DMVR on affine skip mode and direct mode coded blocks to refine motion vector accuracy and thereby improve coding efficiency.

As described above with reference to Equations 2 to 5 and FIGS. 11A, 11B, and 12, in an affine model, a motion vector at sample location (x, y) can be formulated according to Equation 17 below:

$$\{ \begin{matrix}{mv}_{x} = a x + b y + m {v}_{0 x} \\ m {v}_{y} = c x + d y + m {v}_{0 y}\end{matrix}$$

where (mvₓ, mv_{y}) is the derived motion vector at sample location (x, y), (mv₀ₓ, mv_{0y}) is a base MV of the affine model which is the motion vector at sample location (0, 0), and a, b, c, d are the parameters of the affine model which can be derived based on the motion vectors at other two sample locations in the plane. Generally, a base MV of the affine model can be the motion vector at any sample location, not necessarily at location (0, 0): motion vector at sample location (w, h) as the base MV (denoted as (mv_{wx},mv_{hy}), then motion vector at sample location (x, y) can be formulated as Equation 18 below:

$$\{ \begin{matrix}m {v}_{x} = a ( x - w ) + b ( y - h ) + m {v}_{w x} \\ {mv}_{y} = c ( x - w ) + d ( y - h ) + m {v}_{h y}\end{matrix}$$

For a 4-parameter affine model, b is equal to −c and d is equal to a. Thus, a 4-parameter affine model can be formulated as Equation 19 below:

$$\{ \begin{matrix}m {ν}_{x} = a ( x - w ) - c ( y - h ) + m {ν}_{w x} \\ m {ν}_{y} = c ( x - w ) + a ( y - h ) + m {ν}_{h y}\end{matrix}$$

All the affine model parameters, including a, b, c, d and mv_{wx}, mv_{wy} can be refined in DMVR.

According to example embodiments of the present disclosure, bilateral matching search according to DMVR can be applied, except that, in calculating SAD or SATD cost between two predictors of reference picture list 0 and reference picture list 1, motion compensation is performed at sub-block-level. Thus, an affine model is used to derive MV of each sub-block, motion compensation is performed at sub-block-level to get the predictor of the whole current affine coded block, and the SAD and the SATD of two predictors (one is from a reference picture of list 0 and other one is from a reference picture of list 1) of the current affine coded block are calculated, from which the cost of the current search point is derived.

Example embodiments of the present disclosure implement a first step refining the base MV, and a second step refining the non-translational parameters. The details of these two steps are described below.

According to an example embodiment, CPMVs are refined. That is, the initial set of CPMVs refers to an initial position, then MV offset is added to all the CPMVs to get a surrounding search point according to the following Equations 20, 21, 22, 23, 24, and 25:

$${CPMV0\_ l 0}^{′} = CPMV0\_ l 0 + MV\_offset$$

$${CPMV0\_ l 1}^{′} = CPMV0\_ l 1 - MV\_offset$$

$${CPMV1\_ l 0}^{′} = CPMV1\_ l 0 + MV\_offset$$

$${CPMV1\_ l 1}^{′} = CPMV1\_ l 1 - MV\_offset$$

$${CPMV2\_ l 0}^{′} = CPMV2\_ l 0 + MV\_offset$$

$${CPMV2\_ l 1}^{′} = CPMV2\_ l 1 - MV\_offset$$

wherein CPMVx_l0 is the x-th l0 CPMV and CPMVx_l1 is the x-th l1 CPMV. MV_offset is the motion vector offset for a search point; it is the difference between the initial CPMV and the refined CPMV. After CPMVs are refined, the affine model is applied to calculate the MV of each sub-block, then sub-block-level motion compensation is applied to get predictor of the current block.

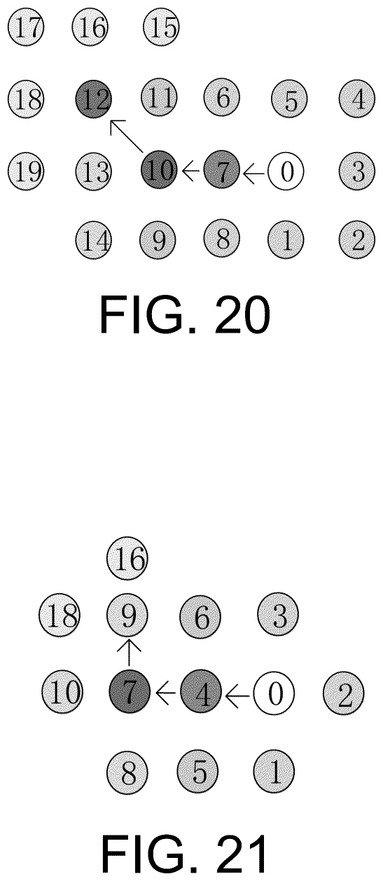

According to example embodiments, bilateral matching search according to DMVR can be applied to affine blocks. According to other example embodiments, as illustrated in FIG. 20 or FIG. 21, a 3×3 square-shape search or 3×3 cross search can be applied to find the best integer MV offset, and then the optimal MV offset can be estimated using a fractional error surface method.

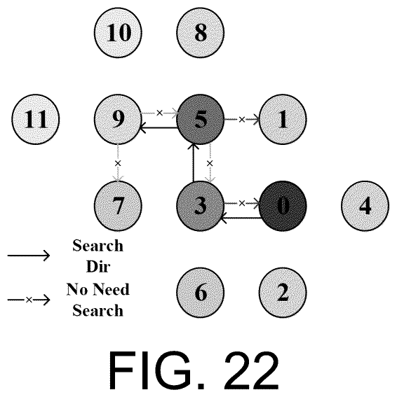

Alternatively, a cross-shape iterative search improves search efficiency. As illustrated in FIG. 22, point 0 is the search center corresponding to the initial MV. The first step is to search the four surrounding points (1 to 4) around the initial center and calculate the bilateral matching SAD cost, determining the point with the lowest cost (point 3). Point 3 is then set as the second search center. After that, as the center (point 3) and the reverse direction of the previous search iteration (point 0) are already searched, only the remaining points (i.e., 5, 6, and 7) are to be searched. If the cost at point 5 is lower than that at points 3, 6, and 7, point 5 is set as the third search center. Next, only the points 8 and 9 are searched, as points 1, 3, 5, 7 are already searched. If the cost at point 9 is lower than that at points 5 and 8, point 9 is set as the fourth search center. At this time, since the number of search iterations is greater than or equal to three, only the points excluding the center (point 9) and the reverse direction of the previous two iterations (points 5 and 7) need to be searched, i.e., points 10 and 11. If, at this time, it is found that point 9 has the lowest cost (i.e., the costs of the four points around point 9 are all greater than point 9), the search will stop and point 9 is set as the optimal point after the integer-pixel search.

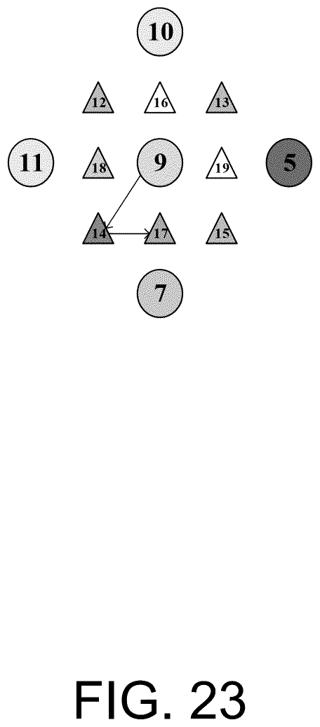

Furthermore, in affine mode, the minimum MV pixel precision is 1/16. Accordingly, search step size is adjusted to achieve higher precision for MV offset refinement. For example, after completing the integer-pixel search in FIG. 23, a ½-pixel search step size can be applied for MV offset refinement. This means setting the MV search step to half of the search step of the integer pixel offset search and performing one iteration of ½-pixel search. The search can be a regular 3×3 square-shape search, or a 3×3 cross-shape search, or an X-shape search. If a search point has smaller BM cost than the center cost, then the two neighboring points of that point with least BM cost in the 3×3 range are continually searched; otherwise, the search stops.

As illustrated in FIGS. 23A and 23B, in the ½ pel search stage, the X-shape search pattern is conducted first and then the two neighboring points of the best point of the X-shape search is searched, or the cross-shape search pattern is conducted first and then two neighboring points of the best point of the cross-shape search pattern is searched. For example, point 9 is the best point after the integer-pixel search. Then, in the ½ pel search stage, the search step is reduced. The search points of ½ pel search are points 12, 13, 14, and 15 along the X-direction. If point 14 has smaller BM cost than that of points 12, 13, and 15, points 17 and 18 are searched continually. If point 17 has smaller BM cost than that of points 14 and 18, point 17 is the optimal point for the ½-pixel search.

Similarly, the ¼-pixel search is like the ½-pixel search, except that search step is set to one-quarter of the integer pixel offset, and the search center is the best point of the ½-pixel search stage (if no better point is found in the ½-pixel search, the best point of the integer-pixel search is used as the search center).

According to the previous example embodiments, the entire search process is divided into different stages. The integer pel search stage is conducted first and followed by the fractional pel search stage. That is to say, a large search step is searched first, followed by searching a small search step. In some other embodiments, the search step is fixed in the whole search process, and there is only one search stage. For example, the search step is ¼-pel, and there is no integer-pel search stage or ½-pel search stage. In the ¼-pel, all the current search patterns can be used to find the best MV offset, and maximum search iteration number can be preset. The search process terminates if the maximum search iteration number is achieved or in a search iteration, the best point is a search center.

To further simplify the search process, for each search point, a 2-tap bilinear interpolation filter is used instead of 8-tap or 12-tap interpolation filter to generate the predictor. The search range and the number of iterations are also limited.

Additionally, since the affine DMVR process changes the MV value, the bandwidth for fetching pixels may increase, and reference samples required by the initial MV value can be retained during the affine DMVR process. However, since the sub-block motion compensation uses a 12-tap interpolation filter and 2-tap interpolation filter used in DMVR, although DMVR process may not require more reference samples than those required by the motion compensation of the initial MV, motion compensation performed by the refined MV may require more reference samples.

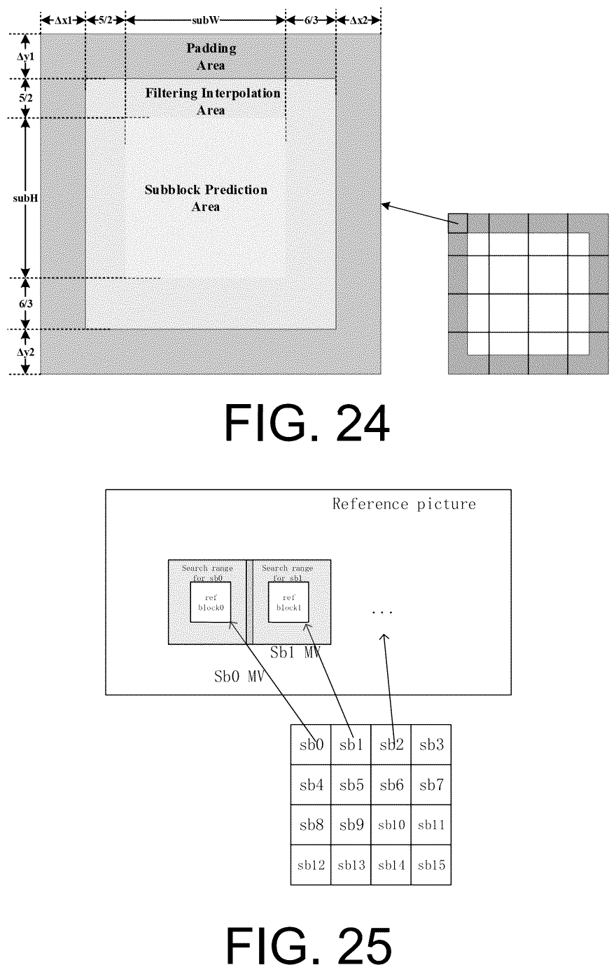

According to example embodiments of the present disclosure, in a final sub-block motion compensation step, the refined MV may requires more reference samples based on the interpolation filter used in the final sub-block motion compensation. As a same offset is added to all the sub-blocks of the CU, only the boundary sub-block need to be considered. Therefore, sample padding is performed in the motion compensation of the bounding sub-blocks if more reference samples are required. That is, when motion compensation for a bounding sub-block requires additional reference samples other than those used by interpolation of the initial MV, the additional reference samples are padded instead of actually fetching from the reference picture. As shown in FIG. 24, denoting Δx1 as the number of samples to be padded in the left side of the left bounding sub-blocks, Δx2 as the number of samples to be padded in the right side of the right bounding sub-blocks, Δy1 as the number of samples to be padded in the above side of the top bounding sub-blocks, Δy2 as the number of samples to be padded in the bottom side of the bottom bounding sub-blocks, according to Equations 26, 27, 28, and 29 as follows:

$$when delta\_x \_pixel >= 0 , Δ x 1 = delta\_x \_pixel , Δ x 2 = 0$$

$$when delta\_x \_pixel < 0 , Δ x 1 = 0 , Δ x 2 = - delta\_x \_pixel$$

$$when delta\_y \_pixel >= 0 , Δ y 1 = delta\_y \_pixel , Δ y 2 = 0$$

$$when delta\_y \_pixel < 0 , Δ y 1 = 0 , Δ x 2 = - delta\_y \_pixel$$

where delta_x_pixel and delta_y_pixel are derived according to Equations 30 and 31 as follows:

$$delta\_x \_pixel = ( ( ( ( x + w ) ≪ 4 ) + mv\_x \_init ) ≫ 4 ) - ( ( ( ( x + w ) << 4 ) + mv\_x \_refined ) >> 4 )$$

$$delta\_y \_pixel = \text{} ( ( ( ( y + h ) ≪ 4 ) + mv\_y \_init ) ≫ 4 ) - ( ( ( ( y + h ) << 4 ) + mv\_y \_refined ) >> 4 )$$

where (mv_x_init, mv_y_init) are the initial MV and (mv_x_refined, mv_y_refined) are the refined MV.

According to other example embodiments, the refinement is applied on the sub-block MV. That is, each sub-block MV is derived with the initial CPMV, and then the MV offset is added to the sub-block MV to refine the sub-block MV according to Equations 32 and 33 as follows:

$$\begin{matrix}MV ( sbx ) {\_ l 0}^{′} = MV ( sbx ) \_ l 0 + MV\_offset \\ MV ( sbx ) {\_ l 1}^{′} = MV ( sbx ) \_ l 1 - MV\_offset\end{matrix}$$

wherein MV(sbx)_l0 and MV(sbx)_l1 are the l0 and l1 MV of sub-block X, respectively. MV_offset with the current search point is added to all the sub-block MVs to get the refined sub-block MVs. Then, motion compensation is performed at sub-block-level with each sub-block MV to get the two predictors of the whole CU. The SAD or the SATD is calculated between the two predictors and cost of the current search is obtained. The search point with least cost is treated as the best point and the corresponding MV_offset is obtained as the best MV_offset. The refined sub-block MV can be calculated with affine model. The search method and the cost calculation method applied in CPMV refinement method can also be applied in the sub-block MV refinement method.

To reduce search complexity, the interpolation of samples of the predictor on each search point within the search window can be done at first and stored at a buffer. For each search point, the predictor of each sub-block can be directly fetched from the buffer without interpolation. As illustrated in FIG. 25, a coding block is divided into 16 8×8 sub-blocks for affine motion compensation. The initial CPMVs are used to calculate initial sub-block MV for each sub-block. For each sub-block, a reference sub-block (i.e., predictor of the sub-block) can be located in the reference picture by the initial sub-block MV. As the refinement is applied on a sub-block MV, so for each search point, all of the reference sub-blocks are shifted by the same MV offset. Thus, for each sub-block, the samples within each search window can be pre-interpolated as the shaded area of FIG. 25. For a search point, the sample of the reference block on that search point can be directly fetched from the search window without interpolation, substantially reducing interpolation.

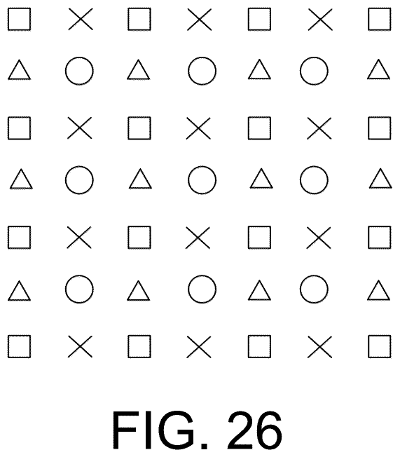

Pre-interpolation can be applied in integer search process and fractional search process. For integer search process, the samples pre-interpolated are all one pixel away from each other; in the fractional, dependent on the phase, the pre-interpolated samples may be stored separately. As illustrated in FIG. 26, square symbols represent the samples for the integer search points which can be all pre-interpolated. X symbols represent the samples at ½ pel position in horizontal direction but at integer position in vertical direction, triangle symbols represent the samples at ½ pel position in vertical direction but at integer position in horizontal direction, and circle, symbols represent the samples at ½ pel position both in horizontal and vertical direction. Given a ½ pel search process, there could be three different phases of samples and the distance between fractional samples with the same phase is also one pixel. The fractional samples with the same type can be pre-interpolated together and different phases of samples may be stored separately.

After the CU level base MV refinement, sub-CU level base MV refinement can also be applied. For example, CU is divided into multiple sub-CUs which is larger than a sub-block (e.g., 16×16 sub-CU) in affine motion compensation. For each sub-CUs, the base MV is further refined: the sub-blocks in one sub-CUs share the same base MV offset. Thus, the final MV of each sub-block can be formulated according to Equations 34 and 35 below:

$$MV ( sbx ) {\_ l 0}^{′} = MV ( sbx ) \_ l 0 + MV\_offset + MV\_offset ( sbCUx )$$

$$MV ( sbx ) {\_ l 1}^{′} = MV ( sbx ) \_ l 1 - MV\_offset - MV\_offset ( sbCUs )$$

wherein MV(sbx)_l0 and MV(sbx)_l1 are the list 0 and list 1 MVs of sub-block X, respectively. MV_offset is the offset obtained in the CU level base MV refinement process and MV_offset(sbCUx) is the MV offset obtained in the sub-CU level base MV refinement for subCU X in which sub-block X is. MV(sbx)_l0′ and MV(sbx)_l1′ are the final refined MV for sub-block X. Then, the motion compensation is performed with the refined sub-block MV at sub-block-level.

To achieve a good trade-off between computation complexity and the performance, the search range can be set dependent on CU size or QPs. For example, a larger CU may need greater refinement and thus need have larger search range and smaller CU may have smaller search range. By way of another example, larger quantization parameters may cause greater distortion, and thus may need larger search range. Larger search ranges can be set for larger QP, and smaller search ranges for smaller QP; at the same time, considering encoding time reduction, setting a small search range for larger QP can significantly reduce the search points, so, alternatively, smaller search range can be set for larger QP and larger search range for smaller QP.

To further reduce computational complexity, a PU size restriction can be imposed. That is, the process of affine DMVR is skipped for some sizes of CUs. For example, affine DMVR is not applied for the CU less than 8×8 or 16×16, or affine DMVR is not applied for the CU larger than 64×64 or 128×128.

To further reduce computational complexity, early termination can be applied in DMVR process for affine blocks. By way of example, if a search point is checked in the search process of the initial motion vector of a previous candidate in the affine merge candidate list, the search point is skipped. By way of another example, if the SAD on a search point is smaller than a predefined threshold, the search process is terminated and the search point is used as the best position after refinement.

According to another example embodiment, to reduce computational complexity for an encoder and a decoder, a fast algorithm is used. By way of example, if the difference of the current affine merge candidate (i.e., the current initial MV) and the previous checked affine merge candidate (i.e., the previous initial MV) is smaller than a threshold, DMVR is skipped for the current affine merge candidate. That is to say, the current affine merge candidate is directly used for motion compensation of the current block without refinement, and the threshold can be dependent on the current block size. The larger blocks have larger threshold than the smaller blocks. By way of another example, the DMVR is disabled for the affine coded block with size smaller/greater than a threshold. That is to say, the small blocks (or the large blocks) do not use DMVR to refine the motion. The threshold can be fixed or signaled in the bitstream.

In addition to base MV refinement, non-translational parameters may also be refined. In the non-translational refinement step, the parameter offsets are searched to minimize the BM cost. Since the affine model is represented by the CPMVs, the CPMVs can be updated by applying the refined non-translational parameters according to Equation 3 or Equation 5 above. Taking the 6-parameter affine model as an example without limitation thereto, the parameter offset search is described by Equation 36 below:

$$\{ \begin{matrix}{a}_{L 0}^{′} = {a}_{L 0} + {a}_{offset} \\ {a}_{L 1}^{′} = {a}_{L 1} - {a}_{offset} \\ {b}_{L 0}^{′} = {b}_{L 0} + {b}_{offset} \\ {b}_{L 1}^{′} = {b}_{L 1} - {b}_{offset} \\ {c}_{L 0}^{′} = {c}_{L 0} + {c}_{offset} \\ {c}_{L 1}^{′} = {c}_{L 1} - {c}_{offset} \\ {d}_{L 0}^{′} = {d}_{L 0} + {d}_{offset} \\ {d}_{L 1}^{′} = {d}_{L 1} - {d}_{offset}\end{matrix}$$

where a, b, c and d denote the four non-translational parameters. (a_{L0}, b_{L0}, c_{L0}, d_{L0}) and (a_{L1}, b_{L1}, c_{L1}, d_{L1}) are the initial non-translational parameters of the affine model for reference picture list 0 and reference picture list 1 respectively;

$$( {a}_{L 0}^{′} , {b}_{L 0}^{′} , {c}_{L 0}^{′} , {d}_{L 0}^{′} ) and ( {a}_{L 1}^{′} , {b}_{L 1}^{′} , {c}_{L 1}^{′} , {d}_{L 1}^{′} )$$

are the corresponding refined non-translational parameters for reference picture list 0 and reference picture list 1 respectively; (a_{offset}, b_{offset}, c_{offset}, d_{offset}) is the parameter offset determined in the search process which minimizes the BM cost.

The 4-parameter affine model has two non-translational parameters a and b: the parameter offset search is conducted in two-dimensional space. Any search pattern applied in the base MV search can be used in the non-translational parameter search, including a square-shape search pattern, a diamond-shape search pattern and a cross-shape search pattern. For example, the cross-shape search pattern used in base MV refinement as shown in FIG. 22 can be used here. Assume the initial search center is (a₀, b₀) and search step is s, then the four neighboring positions to be searched are (a₀, b₀−s), (a₀, b₀+s), (a₀−s, b₀) and (a₀+s, b₀). The BM costs of these four positions are calculated and compared with the search center. If the search center (a₀, b₀) has the least BM cost among these five positions, the search process terminates. Otherwise, the position with the least BM cost is set as the search center of the next search iteration and the search process continues. The search process continues iteratively until the search center has least BM cost or the maximum number of search iterations is reached.

For 6-parameter affine model, there are four non-translational parameters: the parameter offset search is conducted in four-dimensional space. Any search pattern applied in the base MV search process can be used in the non-translational parameter search process, including a square-shape search pattern, a diamond-shape search pattern and a cross-shape search pattern. To reduce computational complexity, a cross-shape search pattern as described above with reference to the 4-parameter affine model is also used for the 6-parameter affine model. Assume that the initial search center is (a₀, b₀, c₀, d₀). According to Equation 5 above, the non-translational parameters a and b are related to the width of the block, while c and d are related to the height of the block. So, the search step is set to s_{w} (for a and b) and sₕ (for c and d). Then the eight neighboring positions to be searched are (a₀−s_{w}, b₀, c₀, d₀), (a₀, b₀−s_{w}, c₀, d₀), (a₀, b₀, c₀−sₕ, d₀), (a₀, b₀, c₀, d₀−sₕ). (a₀, b₀, c₀, d₀+sₕ), (a₀, b₀, c₀+sₕ, d₀), (a₀, b₀+s_{w}, c₀, d₀) and (d₀+s_{w}, b₀, c₀, d₀). The search steps are the same as for the 4-parameter affine model.

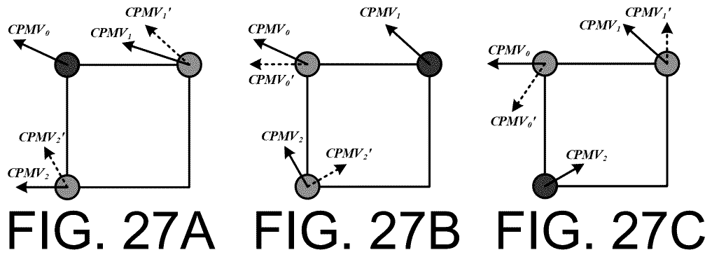

Theoretically, each CPMV can be treated as the base MV which is kept unchanged in the non-translational parameter refinement step. To fully exploit the performance gain, the search process is conducted stage by stage and the CPMVs are fixed as base MV in turn. As illustrated in FIGS. 27A, 27B, and 27C, in each stage, one CPMV is fixed as the base MV of the affine model, and the other two are updated after the refinement of the non-translational parameters. The upper-left (FIG. 27A), upper-right (FIG. 27B), and lower-right (FIG. 27C) CPMVs are sequentially fixed to the base MV, and then the non-translational parameters are refined. After refining the non-translational parameters, the remaining two CPMVs are updated according to the values of the refined non-translational parameters. In each stage, the above-described bilateral matching search process are applied. To further improve coding efficiency, after these three stages, the upper-left CPMV can be fixed as base MV and non-translation parameter can be continually refined. Similarly, the fourth stage can be followed by a fifth stage, a sixth stage or even more, where in each stage, one CPMV is fixed and non-translation parameters are refined.

Computational complexity of non-translational parameter refinement in the above-described process is extremely high. According to example embodiments of the present disclosure, the search process is simplified to reduce computational complexity.

First, the number of refinement stage can be reduced to two or one. Second, the search iteration number in each stage is controlled. For example, the maximum search iteration number is set to 5 for each stage. Different stages may have different pre-set maximum search iteration number. For example, in the first stage when the upper-left CPMV is fixed as base MV, the maximum search iteration number is set to 7; in the second stage when the upper-right CPMV is fixed as base MV, the maximum search iteration number is set to 3; in the third stage when left-bottom CPMV is fixed as base MV, the maximum search iteration number is set to 1.

In addition, early termination can be applied by comparing the current BM cost and the threshold. By way of example, in each search iteration, if the BM cost divided by the block size is less than a first threshold, the search process terminates. By way of another example, the difference between the current BM cost and the BM cost in the last search iteration is calculated and compared with a second threshold, if the difference divided by the block size is less than the second threshold, the search process terminates. When the search iteration of one stage terminates, the process of the next stage may continue.

In addition, the coding results of the first inter frame is checked. If the non-translational parameter refinement is effective in the first inter frame, it will be still used in the following inter frames; otherwise, the non-translational parameter refinement is disabled in the following inter frames. To check whether the non-translational parameter refinement is effective or not, the reduction of the BM cost due to the refinement is calculated. That is, the difference between the BM cost producing with the initial non-translational parameters and the BM cost produced with the refined non-translational parameters are calculated. If the averaged reduction of the BM cost over all the affine block using non-translational parameter refinement in a frame is less than a threshold, it is determined that the non-translational parameter refinement is not effective in this frame and it will be disabled in the following frames. Otherwise, it is determined that the non-translation parameter refinement is effective. And based on the determination, the non-translation parameter refinement of the following frames is enabled or disabled. The check can be done periodically in a video sequence.

Additionally, the usage of the non-translational parameter refinement can be dependent on QP. For a large QP, more distortion will be introduced and thus refinement is more consequential, and for a small QP, less distortion will be introduced in the coding and thus refinement is less consequential. Thus, according to example embodiments of the present disclosure, non-translational parameter refinement or affine DMVR is disabled when the current QP is less than a threshold, and non-translational parameter refinement or affine DMVR are enabled when the QP is larger than a threshold.

Since the 4-parameter affine model is a simplified version of the 6-parameter affine model, in order to further improve the coding performance, the 4-parameter affine model can be treated as the 6-parameter affine model, and the non-translational refinement method of 6-parameter affine model can also be applied to the 4-parameter affine model. After refinement, the 4-parameter affine model is extended to the 6-parameter model.

After the refinement of the non-translational parameters, the updated CPMVs are obtained according to Equation 2 to Equation 4 above. The sub-block MVs are then calculated with the updated CPMVs and the motion compensation can be performed with the sub-block MVs.

The base MV refinement and the non-translational parameter refinement can be used separately or jointly. When both of base MV refinement and non-translational parameter refinement are used, the non-translational parameter refinement can be after the base MV refinement or before base MV refinement.

To control the affine DMVR, the sequence level flag or the picture level flag can be signaled in a sequence header or a picture header. The base MV refinement and the non-translational parameter refinement can be controlled separately or jointly. In one embodiment, base MV refinement and the non-translational parameter refinement is jointly controlled with one flag. If the sequence level flag has a true value, the affine DMVR, including both base MV refinement and non-translational parameter refinement are enabled for the sequence and if the sequence level flag has a false value, the affine DMVR, including both base MV refinement and non-translational parameter refinement are disabled for the sequence. If the picture level flag has a true value, the affine DMVR, including both base MV refinement and non-translational parameter refinement are enabled for the picture and if the picture level flag has a false value, the affine DMVR, including both base MV refinement and non-translational parameter refinement are disabled for the picture.

According to another example embodiment, base MV refinement and non-translation parameter refinement are controlled separately with two flags. If the first sequence level flag has a true value, the base MV refinement is enabled for the sequence and if the first sequence level flag has a false value, the base MV refinement is disabled for the sequence. If the second sequence level flag has a true value, the non-translational parameter refinement is enabled for the sequence and if the second sequence level flag has a false value, the non-translational parameter refinement is disabled for the sequence. If the first picture level flag has a true value, the base MV refinement is enabled for the picture and if the first picture level flag has a false value, base MV refinement is disabled for the picture. If the second picture level flag has a true value, the non-translational parameter refinement is enabled for the picture and if the second picture level flag has a false value, non-translational parameter refinement is disabled for the picture. Additionally, the value of the second flag may be dependent on the first flag. For example, when the first flag has a true value, the second flag may have a true or false value, and if the first flag has a false value, the second flag can only have a false value.

Persons skilled in the art will appreciate that all of the above aspects of the present disclosure may be implemented concurrently in any combination thereof, and all aspects of the present disclosure may be implemented in combination as yet another embodiment of the present disclosure.

FIG. 28 illustrates an example system 2800 for implementing the processes and methods described above for implementing decoder-side motion vector refinement.

The techniques and mechanisms described herein may be implemented by multiple instances of the system 2800 as well as by any other computing device, system, and/or environment. The system 2800 shown in FIG. 28 is only one example of a system and is not intended to suggest any limitation as to the scope of use or functionality of any computing device utilized to perform the processes and/or procedures described above. Other well-known computing devices, systems, environments and/or configurations that may be suitable for use with the embodiments include, but are not limited to, personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, implementations using field programmable gate arrays (“FPGAs”) and application specific integrated circuits (“ASICs”), and/or the like.

The system 2800 may include one or more processors 2802 and system memory 2804 communicatively coupled to the processor(s) 2802. The processor(s) 2802 may execute one or more modules and/or processes to cause the processor(s) 2802 to perform a variety of functions. In some embodiments, the processor(s) 2802 may include a central processing unit (“CPU”), a graphics processing unit (“GPU”), both CPU and GPU, or other processing units or components known in the art. Additionally, each of the processor(s) 2802 may possess its own local memory, which also may store program modules, program data, and/or one or more operating systems.

Depending on the exact configuration and type of the system 2800, the system memory 2804 may be volatile, such as RAM, non-volatile, such as ROM, flash memory, miniature hard drive, memory card, and the like, or some combination thereof. The system memory 2804 may include one or more computer-executable modules 2806 that are executable by the processor(s) 2802.

The modules 2806 may include, but are not limited to, one or more of an encoder 2808 and a decoder 2810.

The encoder 2808 may be a VVC-standard encoder implementing any, some, or all aspects of example embodiments of the present disclosure as described above, and executable by the processor(s) 2802 to configure the processor(s) 2802 to perform operations as described above.

The decoder 2810 may be a VVC-standard encoder implementing any, some, or all aspects of example embodiments of the present disclosure as described above, executable by the processor(s) 2802 to configure the processor(s) 2802 to perform operations as described above.

The system 2800 may additionally include an input/output (“I/O”) interface 2840 for receiving image source data and bitstream data, and for outputting reconstructed pictures into a reference picture buffer or DPB and/or a display buffer. The system 2800 may also include a communication module 2850 allowing the system 2800 to communicate with other devices (not shown) over a network (not shown). The network may include the Internet, wired media such as a wired network or direct-wired connections, and wireless media such as acoustic, radio frequency (“RF”), infrared, and other wireless media.

Some or all operations of the methods described above can be performed by execution of computer-readable instructions stored on a computer-readable storage medium 2830, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory (such as random-access memory (“RAM”)) and/or non-volatile memory (such as read-only memory (“ROM”), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient or non-transitory computer-readable storage medium 2830 is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (“PRAM”), static random-access memory (“SRAM”), dynamic random-access memory (“DRAM”), other types of random-access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. A computer-readable storage medium employed herein shall not be interpreted as a transitory signal itself, such as a radio wave or other free-propagating electromagnetic wave, electromagnetic waves propagating through a waveguide or other transmission medium (such as light pulses through a fiber optic cable), or electrical signals propagating through a wire.

The computer-readable instructions stored on one or more non-transient or non-transitory computer-readable storage media that, when executed by one or more processors, may perform operations described above with reference to FIGS. 1A-27. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A computing system, comprising:
one or more processors, and
a computer-readable storage medium communicatively coupled to the one or more processors, the computer-readable storage medium storing computer-readable instructions executable by the one or more processors that, when executed by the one or more processors, perform associated operations comprising:
performing motion prediction upon a coding block coded by affine skip mode or direct mode based on an affine model;
performing motion vector refinement upon the coding block; and
signaling a sequence parameter set (“SPS”) flag or a picture-level flag in a bitstream associated with a video sequence indicating either or both of refining a base motion vector of the affine model and refining non-translational parameters of the affine model.

2. The computing system of claim 1, wherein performing motion vector refinement upon the coding block comprises:
refining a base motion vector of the affine model; and
refining non-translational parameters of the affine model.

3. The computing system of claim 2, wherein refining a base motion vector of the affine model comprises adding a motion vector offset to each control point motion vector (“CPMV”) of the coding block.

4. The computing system of claim 3, wherein the operations further comprise:
determining the motion vector offset by searching, iteratively, points surrounding an initial motion vector to minimize bilateral matching (“BM”) cost by an integer-pixel search step; and
determining the motion vector offset by searching, iteratively, to minimize BM cost by a fractional search step.

5. The computing system of claim 3, wherein the operations further comprise determining the motion vector offset by searching, iteratively, points surrounding an initial motion vector to minimize bilateral matching (“BM”) cost by a fractional search step.

6. The computing system of claim 2, wherein performing motion vector refinement upon the coding block comprises performing motion vector refinement upon a sub-block of the coding block;
wherein refining a base motion vector of the affine model comprises adding a motion vector offset to each control point motion vector (“CPMV”) of the sub-block; and
wherein the operations further comprise:
performing affine motion compensation based on a refined motion vector of the sub-block, wherein the sub-block comprises a bounding sub-block; and
padding a plurality of samples on a side of the bounding sub-block.

7. The computing system of claim 6, wherein the operations further comprise:
determining a search window for performing motion vector refinement upon a sub-block based on the motion vector offset;
pre-interpolating each sample of the search window before determining a motion vector offset by searching to minimize bilateral matching (“BM”) cost; and
determining the motion vector offset by searching, over a plurality of iterations, points surrounding an initial motion vector by an integer-pixel search step or a fractional search step;
wherein pre-interpolating each sample of the search window is performed separately before each search of the plurality of iterations.

8. The computing system of claim 2, wherein performing motion vector refinement upon the coding block comprises performing motion vector refinement upon a sub-coding unit (“CU”) of the coding block, wherein a sub-CU is larger than a sub-block of the coding block.

9. The computing system of claim 2, wherein performing motion vector refinement upon the coding block comprises searching points surrounding an initial motion vector, wherein the search range varies depending on coding unit (“CU”) size or depending on quantization parameter (“QP”) size.

10. The computing system of claim 2, wherein refining non-translational parameters of the affine model comprises searching, over a plurality of iterations, points surrounding a plurality of non-translational parameters to minimize bilateral matching (“BM”) cost;
wherein refining non-translational parameters of the affine model further comprises holding a control point motion vector (“CPMV”) of the coding block fixed while refining each other CPMV of the coding block; and
wherein, for each different CPMV held fixed, a different maximum number of search iterations is set.

11. The computing system of claim 2, wherein a search of the plurality of iterations terminates upon determining a BM cost exceeding a threshold when divided by a block size, or a difference in BM costs between iterations exceeding a threshold when divided by a block size.

12. A method, comprising:
decoding, from a bitstream associated with a video sequence, a sequence parameter set (“SPS”) flag or a picture-level flag indicating either or both of refining a base motion vector of the affine model and refining non-translational parameters of the affine model
performing motion prediction upon a coding block coded by affine skip mode or direct mode based on an affine model; and
performing motion vector refinement upon the coding block.

13. The method of claim 12, wherein performing motion vector refinement upon the coding block comprises:
refining a base motion vector of the affine model; and
refining non-translational parameters of the affine model.

14. The method of claim 13, wherein refining a base motion vector of the affine model comprises adding a motion vector offset to each control point motion vector (“CPMV”) of the coding block.

15. The method of claim 14, further comprising:
determining the motion vector offset by searching, iteratively, points surrounding an initial motion vector to minimize bilateral matching (“BM”) cost by an integer-pixel search step; and
determining the motion vector offset by searching, iteratively, to minimize BM cost by a fractional search step.

16. The computing system of claim 14, further comprising determining the motion vector offset by searching, iteratively, points surrounding an initial motion vector to minimize bilateral matching (“BM”) cost by a fractional search step.

17. The method of claim 13, wherein performing motion vector refinement upon the coding block comprises performing motion vector refinement upon a sub-block of the coding block;
wherein refining a base motion vector of the affine model comprises adding a motion vector offset to each control point motion vector (“CPMV”) of the sub-block; and
further comprising:
performing affine motion compensation based on a refined motion vector of the sub-block, wherein the sub-block comprises a bounding sub-block; and
padding a plurality of samples on a side of the bounding sub-block.

18. The method of claim 17, further comprising:
determining a search window for performing motion vector refinement upon a sub-block based on the motion vector offset;
pre-interpolating each sample of the search window before determining a motion vector offset by searching to minimize bilateral matching (“BM”) cost; and
determining the motion vector offset by searching, over a plurality of iterations, points surrounding an initial motion vector by an integer-pixel search step or a fractional search step;
wherein pre-interpolating each sample of the search window is performed separately before each search of the plurality of iterations.

19. The method of claim 13, wherein refining non-translational parameters of the affine model comprises searching, over a plurality of iterations, points surrounding a plurality of non-translational parameters to minimize bilateral matching (“BM”) cost;
wherein refining non-translational parameters of the affine model further comprises holding a control point motion vector (“CPMV”) of the coding block fixed while refining each other CPMV of the coding block; and
wherein, for each different CPMV held fixed, a different maximum number of search iterations is set.

20. A method of storing a bitstream associated with a video sequence, the method comprising:
generating a bitstream comprising:
a sequence parameter set (“SPS”) flag or a picture-level flag indicating either or both of refining a base motion vector of the affine model and refining non-translational parameters of the affine model; and
storing the bitstream in a non-transitory computer-readable storage medium.
